(19) United States
(12) Patent Application Publication
(10) Pub. No.: US 2009/0037228 A1
(43) Pub. Date: Feb. 5, 2009

(54) System and Method for Analyzing Complex Insurance Policy Proposals

(76) Inventor: Justin Engel, Reno, NV (US)

Correspondence Address: WHITE-WELKER & WELKER, LLC, P.O. BOX 199, CLEAR SPRING, MD, 21722-0199, US

(21) Appl. No.: 12/013,502

(22) Filed: Jan. 14, 2008

Related U.S. Application Data
(60) Provisional application No. 60/953,537, filed on Aug. 2, 2007.

(51) Int. Cl. G06Q 40/00

(52) U.S. Cl. 705/4

(57) ABSTRACT

A system and method for providing businesses with comparative insurance proposal information. The present invention is embodied in an online software system that provides a home page for both agents and businesses and a business only page that provides additional information such as tips on saving money and purchasing insurance. A business first provides underwriting data to those wanting to provide quotes. The insurance agent or representative of the insurance company uploads the proposal(s) to the insurance valuator system via manual or electronic methods the proposed limits and coverage. An automated communication is then generated and sent to the business when the agent logs in and when it is complete. After the proposal information is uploaded, custom reports (based on sets of industry specific rules, guidelines or other criteria) can be generated and viewed or printed by the business.

### CROSS REFERENCE TO RELATED APPLICATIONS

This application claims priority from U.S. Provisional Patent Application Ser. No. 60/953,537, entitled “System and Method for Analyzing Complex Insurance Policy Proposals”, filed on 2 Aug. 2007.

### FEDERALLY SPONSORED RESEARCH

Not Applicable

### SEQUENCE LISTING OR PROGRAM

### Not Applicable

### TECHNICAL FIELD OF THE INVENTION

The present invention relates generally to electronic commerce. More specifically, the present invention relates to the methods, systems, and apparatus of analyzing complex insurance policy proposals with respect to the use of an apparatus to business owners for the purpose of analyzing insurance quotes and proposals.

### BACKGROUND OF THE INVENTION

The process of purchasing insurance has become increasingly complex for businesses large and small. Businesses from manufacturers to auto dealers face the task of analyzing complex insurance policy proposals that often are lacking the detail to make informed decisions. Thus it is difficult to compare the various proposals. In addition there is significant difference in the coverage forms and limits that various insurance companies use in focusing on the various SIC Codes that they have an interest in. The level of disclosure of important terms is often lacking or hard to understand, leaving the business decision maker with difficult choices that often turn to price as the only benchmark. This apparatus is designed to be used by the business or consultants or other entities representing the business, for decision making purposes based upon getting detailed comparative coverage reports from the input completed by insurance agents, brokers, insurance companies or other interested parties representing insurance carriers. (hereafter collectively referred to as “agents”) proposing the business insurance need. The benefits to the business include; reduced time analyzing complex proposals, premium savings from effectively bidding the insurance need, education on risks and exposures, and confidence that the proper coverage is being purchased.

Historically, a business purchases an insurance policy on an annual contract. Depending upon his business class, he may use only a single broker, or he may have multiple brokers or insurance company direct salespeople soliciting his insurance needs. Depending upon his SIC Code the policy being purchased could comprise two to ten different coverage parts including; property, liability, auto and umbrella to name a common few. The process is frequently a two to three month process whereby the insurance agents collect underwriting information, underwriters process the information, a proposal is generated, and the agent reviews the proposal with the business.

The prior art teaches several systems and methods for selling and offering insurance and securities for sale, but all have shortcomings with respect to the present invention. For example, U.S. Pat. No. 5,758,328 teaches a computerized system for forming a computer based communications network of network members inclusive of network buyers and or network vendors for processing requests for quotation for goods and services through at least one central processing unit including operating system software for controlling the central processing unit, storage means containing the identification of network members, means for network buyers to generate request for quotation for goods and/or services, means for transmitting said request for quotation to said central processing unit, filter means for selecting appropriate network members to receive said request for quotation based on filter conditions defined by the buyer in said request for quotation and/or by the vendor and/or by the central processing unit, means for broadcasting said request for quotation to the network members selected by said filter means and means for responding to the generator of said request.

U.S. Pat. No. 6,594,635 teaches a data processing system is disclosed that provides an efficient market for: (1) the provision of insurance and reinsurance between insurers and those seeking insurance and reinsurance, and (2) the sale of insurance between reinsurers. In particular, the data processing system provides an efficient market for the provisioning of insurance and reinsurance that not only invites insurers, insurance seekers, and reinsurers to patronize the system, but whose conventions induce them to patronize the system.

U.S. Pat. No. 7,124,088 teaches an Internet on-line insurance policy service system that facilitates real-time automated communication of policy information, adjustment of policy parameters, calculation and communication of resulting policy quotes, and implementation of policy changes, while obviating insurer personnel involvement and supervision of the communication. The system comprises a plurality of software modules relating to on-line real-time communication of existing policy information, testing of a wide range of variations in policy parameters, computing and communicating changes in policy premiums that would result from such variations, communicating desired changes in policy parameters and implementing desired policy changes. Other modules relate to communication of claims information and the providing of on-line forms.

U.S. Pat. No. 5,970,464 teaches a computer implemented method of underwriting profitability analysis delivers the analytic process to a wide cross section of insurance decision makers. The underwriting profitability analysis system leverages an existing investment in databases and improves underwriting business processes. Data mining techniques are applied to historical policy and claims to extract rules that describe policyholders with homogeneous claim frequency and severity characteristics. These rule sets are used to classify policyholders into distinct risk groups, each with its own set of characteristics, including pure premium. Breaking up a book of business into segments allows identification of sub-populations of policyholders that distinctly deviate from the expected normal pure premium. This identification allows the insurance business analysts to interactively adjust eligibility criteria and examine altered characteristics of the covered segments until satisfactory.

U.S. Pat. No. 4,831,526 fully computerized insurance system is provided for processing and preparing applications for insurance and premium quotations and for preparing and writing insurance contracts. A central processor, including a data bank into which data is written and from which data is read, this data including information regarding the risk to be insured, client information, insurance premium information and predetermined text data for incorporation with insurance contracts, is interconnected with plural terminals, including input and display apparatus, to permit data to be entered and retrieved from the central processor. The central processor is also provided with the capability of merging entered or stored data with predetermined text data to compile data embodying a final insurance document. This data is then communicated to a printer for printing of the insurance document.

U.S. Patent Application Publication 20070129972 discloses systems and methods for facilitating the dispensing of insurance and of an insurance company selling insurance policies are provided, which may be network or Internet based, and may be managed through a general agent. Policy information from insurance companies may be received or stored. Data may be received from customers and insurance rates or quotes provided, which may be from competing companies. An instruction to purchase and payment may be received and proof of coverage, such as printing a document, may be facilitated. Data may be input directly by a customer or by an agent on behalf of the customer. The policy information, customer data, and premiums may be provided to the insurance companies. Insurance agents may advertise, and may refer customers from their own websites in exchange for commissions. The insurance offered for sale may be, automobile or specialty insurance, and may provide coverage in another country.

U.S. Patent Application Publication 20070038488 discloses an Internet on-line insurance policy service system that facilitates real-time automated communication of policy information, adjustment of policy parameters, calculation and communication of resulting policy quotes, and implementation of policy changes, while obviating insurer personnel involvement and supervision of the communication. The system comprises a plurality of software modules relating to on-line real-time communication of existing policy information, testing of a wide range of variations in policy parameters, computing and communicating changes in policy premiums that would result from such variations, communicating desired changes in policy parameters and implementing desired policy changes. Other modules relate to communication of claims information and the providing of on-line forms.

U.S. Patent Application Publication 20060241982 discloses a method and system for automated processing of insurance information. A universal electronic insurance application form is automatically created and sent and received electronically. The universal electronic insurance information form includes a set of common insurance census information required by health insurance carriers to provide health insurance quotes. The universal electronic insurance information form is used to obtain group health insurance rate quotes automatically from multiple health insurance carriers.

U.S. Patent Application Publication 20060031104 discloses a method for optimizing insurance estimates for an insurance plan includes ascertaining the number of insured units to be covered by the plan, and obtaining premium quotes from an insurance carrier, the premium quotes corresponding to the number of insured units and to a plurality of cap levels of the plan. The method further includes obtaining statistical loss data for the insured units and applying the obtained statistical loss data to each of the cap levels.

U.S. Patent Application Publication 20050197866 provides a system, method, and computer-readable medium for providing pre-need services. The pre-need insurance services system includes a data processing unit, a customer data storage unit, a quote data storage unit, and an insurance data storage unit. The data processing unit receives customer information from a user interface. The customer information is stored and pre-need insurance quotes are received, prepared, and stored. Insurance applications can be prepared from the insurance quotes. Additionally, insurance assignment forms and insurance claims can be prepared. The pre-need insurance services system also provides a business data storage unit for customization and creation of various business forms.

U.S. Patent Application Publication 20020026334 discloses a method and apparatus are provided that allow insurance agents to virtually present insurance quotes to potential clients over the Internet and the web. This is accomplished by first collecting information from a user and generating an insurance quote based on the information collected from the user. An agent list is then presented to the user, who, in turn, selects an agent from the agent list. Finally, the insurance quote is presented to the user together with information regarding the selected agent. As a result, the insurance quote is presented to the user as if the selected agent were actually providing the quote directly to the user. This presentation mode allows captive agents to maintain their exclusive quote presentation role with users of the system, while, at the same time, eliminating the time delay introduced by the off-line quoting process.

U.S. Patent Application Publication 20020116228 discloses an Internet on-line insurance policy service system that facilitates real-time automated communication of policy information, adjustment of policy parameters, calculation and communication of resulting policy quotes, and implementation of policy changes, while obviating insurer personnel involvement and supervision of the communication. The system comprises a plurality of software modules relating to on-line real-time communication of existing policy information, testing of a wide range of variations in policy parameters, computing and communicating changes in policy premiums that would result from such variations, communicating desired changes in policy parameters and implementing desired policy changes. Other modules relate to communication of claims information and the providing of on-line forms.

U.S. Patent Application Publication 20020120476 discloses systems and methods for facilitating the dispensing of insurance and of an insurance company selling insurance policies are provided, which may be network or Internet based, and may be managed through a general agent. Policy information from insurance companies may be received or stored. Data may be received from customers and insurance rates or quotes provided, which may be from competing companies. An instruction to purchase and payment may be received and proof of coverage, such as printing a document, may be facilitated. Data may be input directly by a customer or by an agent on behalf of the customer. The policy information, customer data, and premiums may be provided to the insurance companies. Insurance agents may advertise, and may refer customers from their own websites in exchange for commissions. The insurance offered for sale may be, automobile or specialty insurance, and may provide coverage in another country.

### SUMMARY OF THE INVENTION

The present invention is a system and method for providing businesses with comparisons of insurance proposals through reports and other means. The present invention is embodied in an online software system the provides a home page for both agents and businesses and a business only page that provides additional information such as tips on saving money, insurance glossary, and other tools for purchasing insurance.

A business first provides underwriting data to those wanting to provide quotes. When the insurance agent has his proposal ready he logs on to the system and completes forms, via manual or electronic transmission, regarding limits and coverages. An automated communication is then generated and sent to the business when the agent logs in and when it is complete. When proposal information is uploaded, custom reports can be generated and viewed by the business such as summary reports, detail reports, red flag identification, or difference reports that compare the various competing insurance proposals.

A business can sign on to the system at any time to retrieve reports. When an agent gives their proposal, businesses can have an agent sign to confirm coverages.

The present invention is embodied and enabled via a web site with a proprietary database that is inserted into the process between the collection of underwriting and the agent review of the proposal with the business owner. The amount of data entry required by the business is narrowed to only a few questions since the proposing agents are responsible for providing their proposal information to the system.

The web site has a home page for the business to manage the insurance proposal, and a home page for the proposing agents to enter information from their proposals including but not limited to; proposed limits, specific SIC Code related insurance coverage questions, policy enhancements and endorsements, and policy restrictions and endorsements.

The web site provides for automated communication to the agent and business to manage and ensure timely completion of the proposal by the proposing agents.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIGS. 1 and 2 are flow charts illustrating the current process of the present invention;

FIG. 3 is a flow chart illustrating the typical insurance purchase process;

FIG. 4 is a flow chart illustrating the insurance valuator process;

FIG. 5 shows the physical layout and connectivity of the system;

FIG. 6 is a flow chart illustrating the database and functionality of the system of the present invention;

FIG. 7 is a flow chart illustrating the functionality of the tabbed navigation system of the system's home page and web site pages;

FIG. 8 is a flow chart illustrating the process steps of a client using the system of the present invention;

FIG. 9 is a flow chart illustrating the process steps of an agent using the system of the present invention in response to a client's input;

FIG. 10 is a flow chart illustrating the type and features of reports generated by the present invention;

FIG. 11 is a flow chart illustrating the functionality of the automated communication component of the present invention;

FIG. 12 is a flow chart showing an overview of the system of the present invention; FIGS. 13a-13l are screen shots of sample reports generated by the present invention;

FIGS. 14a-14d are screen shots of sample reports of liability limits generated by the present invention;

FIGS. 15a-15f are screen shots of sample critical reports generated by the present invention;

FIG. 16 is a screen shot of the GUI dashboard of the present invention;

FIG. 17 is a screen shot of the questions group web page of the present invention; and

FIGS. 18a-18b are screen shots of the GUI of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The present invention is a method and system for analyzing complex insurance policy proposals with respect to the use of an apparatus by business owners for the purpose on analyzing insurance quotes and proposals.

The present invention is a system and method for providing businesses with comparative insurance proposal information. The present invention is embodied in an online software system the provides a home page for both agents and businesses and a business only page that provides additional information such as tips on saving money, insurance glossary and purchasing insurance. In this document the word “agent” refers to a sales agent of an insurance company who is a “direct writer”, an individual agent, an insurance company a broker, or any other entity representing insurance companies.

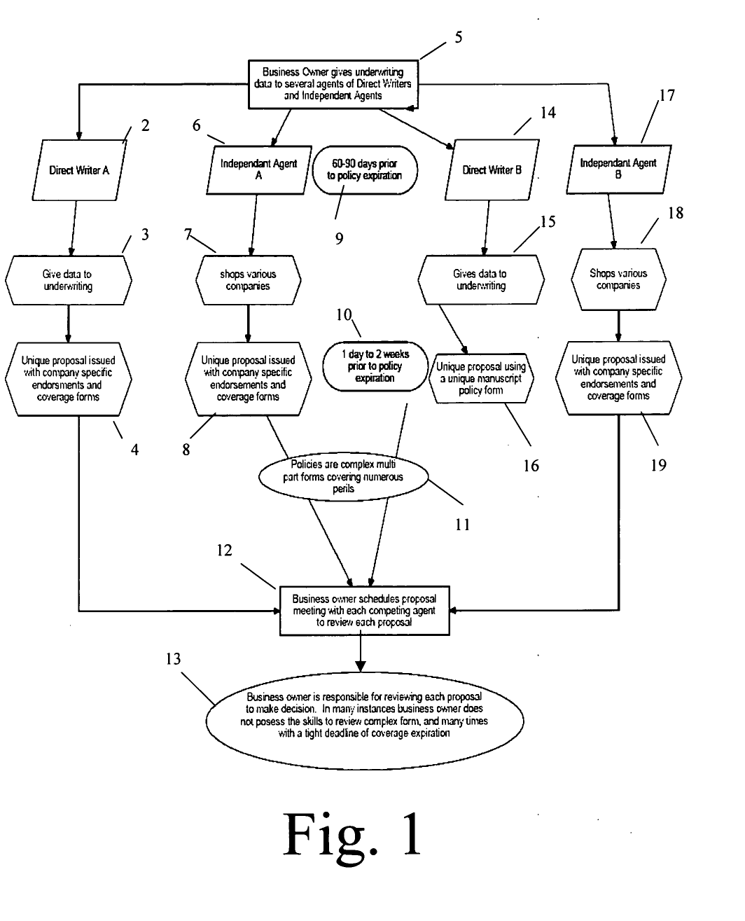

Now referring to FIG. 1, a typical or common current process for complex insurance 1 of the present invention is illustrated. Typically within 60-90 days prior to a policy's expiration 9, business owner gives underwriter data to several agents of direct writers and independent agents 5.

Within one to two weeks prior to a policy's expiration 10, a first direct writer 2 then gives the data to the direct writer's underwriting 3. A unique proposal is then issued with company specific endorsements and coverage forms 4. Concurrently, a second direct writer 14 then gives the data to the direct writer's underwriting 15. Within one to two weeks prior to a policy's expiration 10, a unique proposal is then issued with company specific endorsements and coverage forms 16.

Additionally, a plurality of independent agents 6 & 17 are provided underwriting data by a business owner 5. The independent agents 6 & 17 then show various companies 7 & 18. The independent agents 6 & 17 then each generate a unique proposal with company specific endorsements and coverage forms 8 & 19.

Once all proposals are received, a business owner then schedules a proposal meeting with each competing agent to review each proposal 12. The business owner is then responsible for reviewing each proposal to make a decision. In many instances business owners do not possess the skills to review complex forms and may times under a tight deadline of coverage expiration they do not have the time to compare non-uniform complex offers 13.

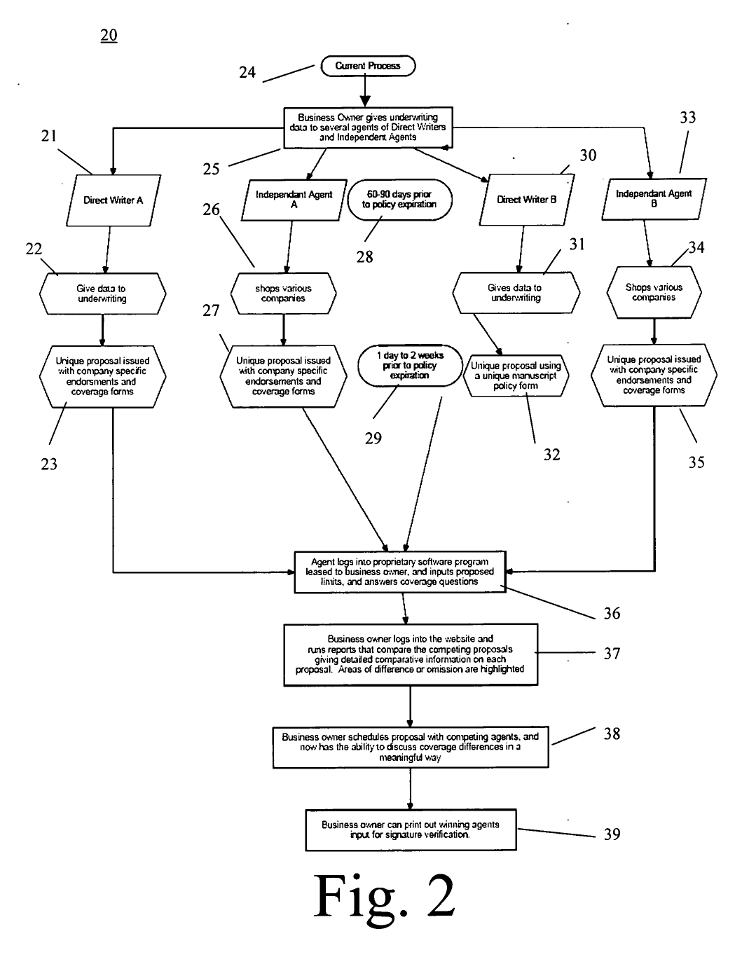

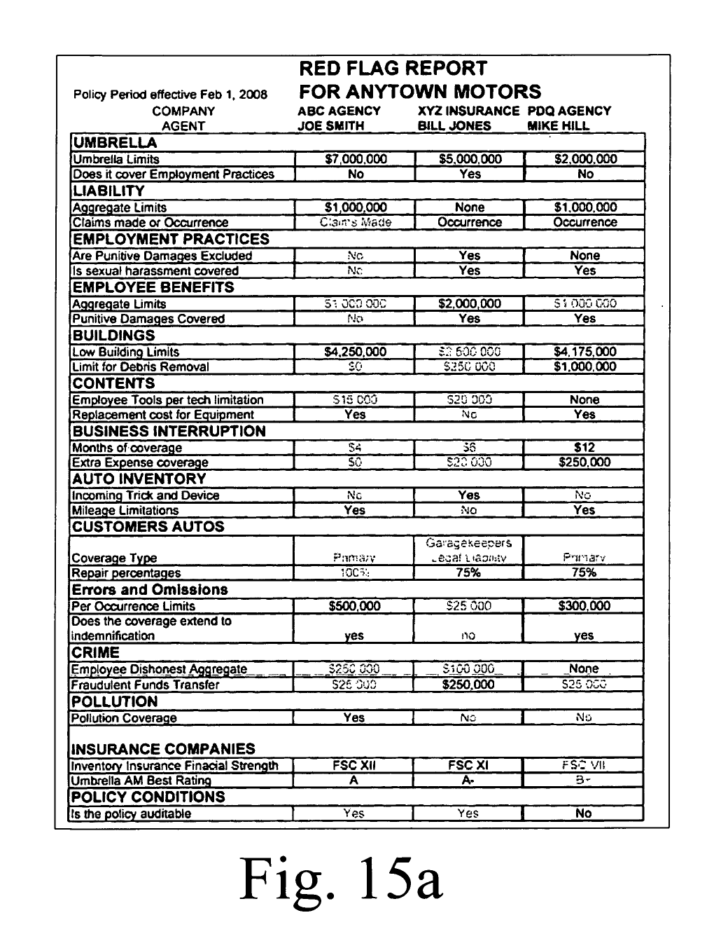

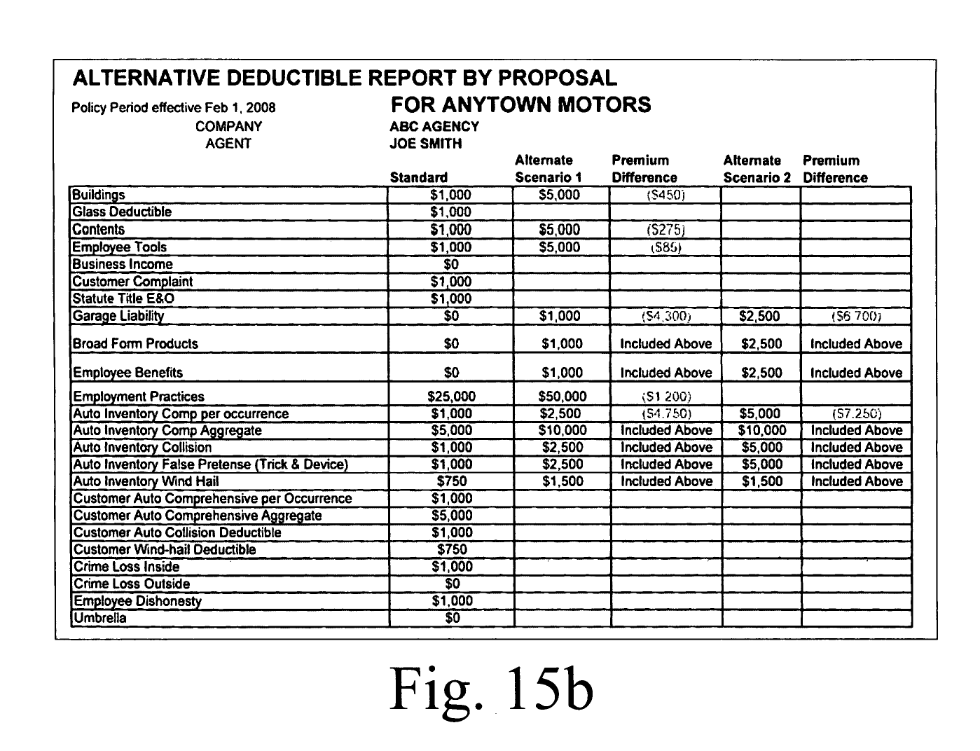

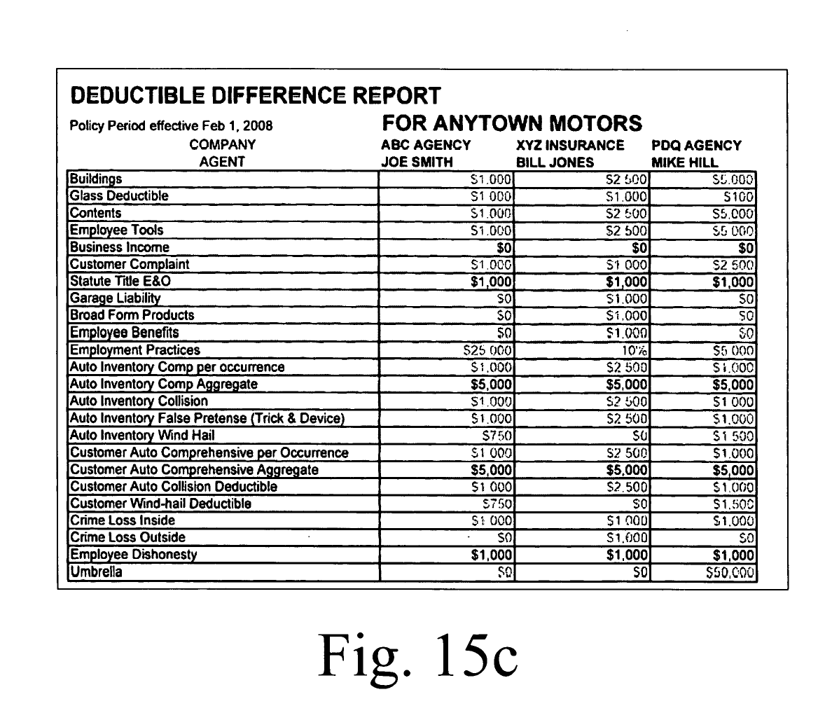

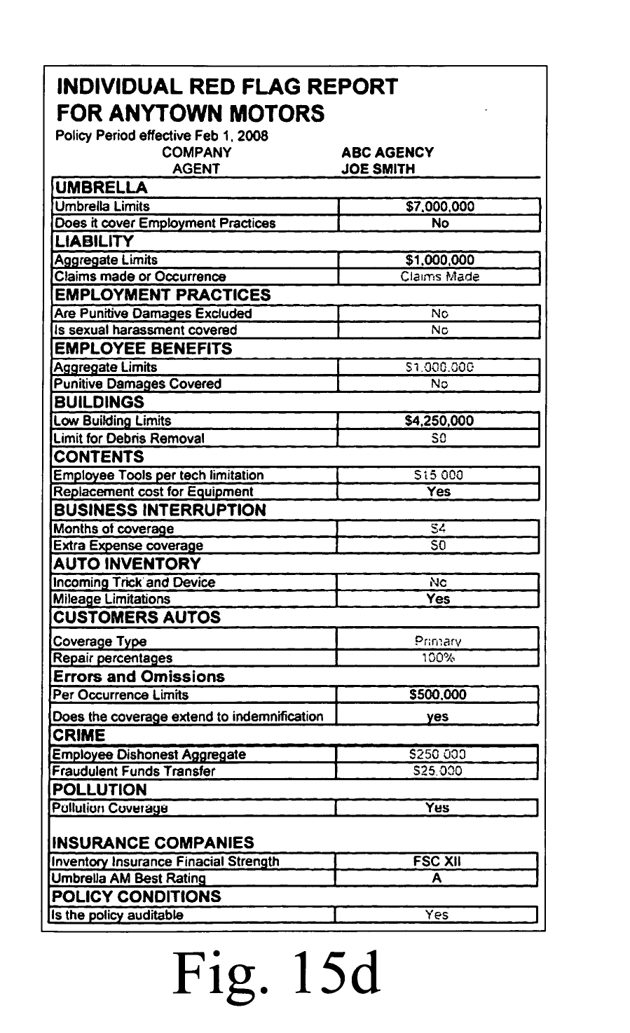

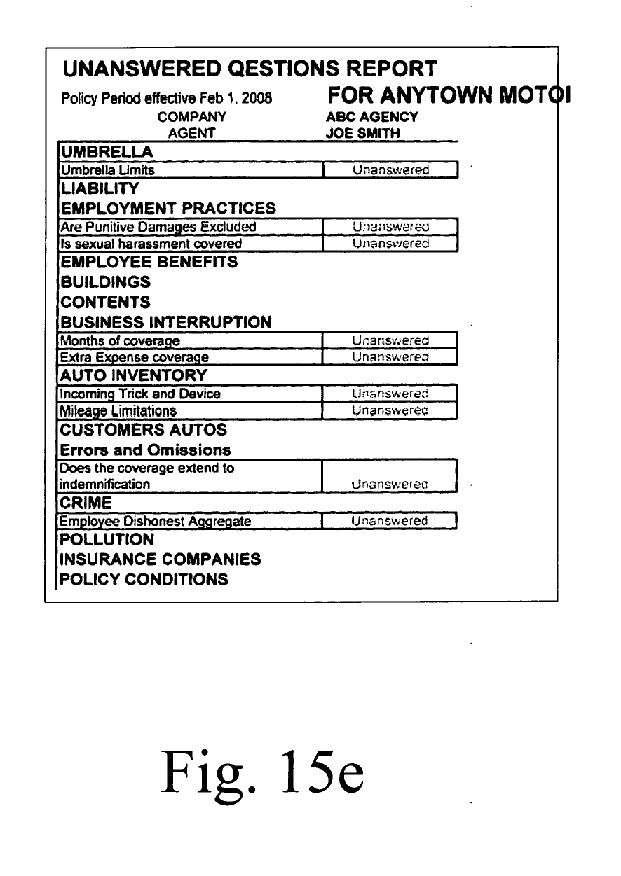

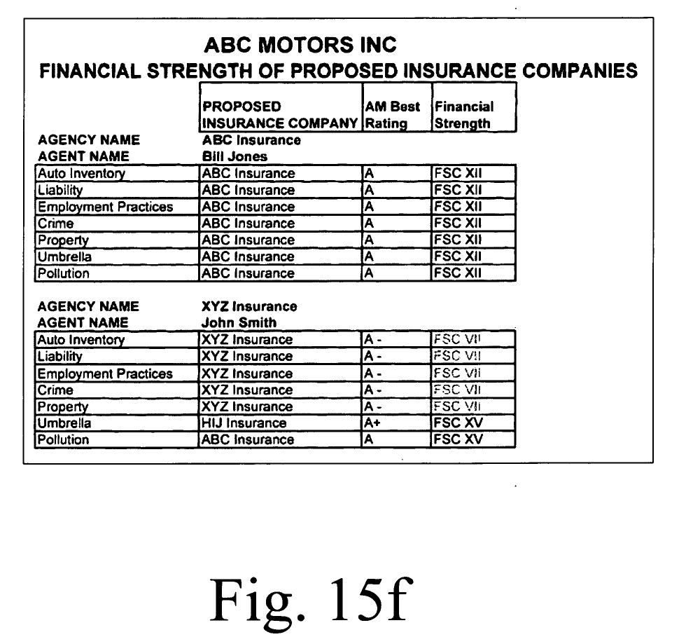

Now referring to FIG. 2, the current process of the present invention is continued. A business first provides underwriting data to those wanting to provide quotes 5. When the insurance agent has his proposal ready he logs on to the system and complete forms regarding limits and coverages 36. An automated communication is then generated and sent to the business when the agent logs in and when it is complete. When proposal information is uploaded, custom reports are generated as illustrated in FIGS. 15a-15f, that can be viewed by the business such as summary reports 191 & 192, detail reports 186, red flag identification 189 & 190, or difference reports 187.

A business can sign on to the system at any time to retrieve reports 37. The system provides reports that compare the competing proposals giving detailed information on each proposal as well as comparative and analytical information of the various proposals. All areas of difference or omission are highlighted. When an agent gives their proposal, businesses can have an agent sign to confirm coverages. Business owners can also schedule proposals with competing agents, and now have the ability to discuss coverage differences in a meaningful manner 38. If coverage is selected, business owners can print out winning agents input for signature verification 39.

Insurance policies are typically comprised of forms that describe coverage, and have the necessary contractual verbiage to confer and describe the coverage being offered or provided. This includes coverage language that the system of the present invention can query. Over 90% of policies are constructed using pre-printed forms created by several firms. ISO (insurance services office) is one such organization. The software of the present invention is designed so that one answer can affect many others. As such, the present invention can program the system so that if a form number is input, the system will populate numerous fields. The effect will be to minimize the time an agent spends inputting info into the system of the present invention, reduces the chance and actual number of errors, and allows for more detailed analysis when a customer desires the detail.

Insurance policies are broken down into several parts, including but not limited to; declaration pages that state what is covered and the limits if liability. The policy itself is comprised of standardized forms or manuscript contracts that specify the contractual obligation of the insurance company. In addition, endorsements are attached that may be standardized language or manuscript forms that either add, eliminate or modify the obligation of the insurance carrier. Where standardized forms apply the software of the present invention has the ability to provide the comparative analysis by the entry of the standardized form number into the system.

When a standardized form number is input into the system, the system populates the database with the appropriate information, which reduces the time an agent spends inputting data, reduces the chance for errors, allows for greater comparative detail, and allows for the coverage form to be viewed by the prospective customer.

### Preferred Embodiment

In a preferred embodiment the present invention focuses on sales process of commercial insurance where insurance companies employ their own sales staff, or where multiple brokers or agents are contracted to bid a business risk. The companies that employ their own staff are commonly referred to as Direct Writers also referred to as agents.

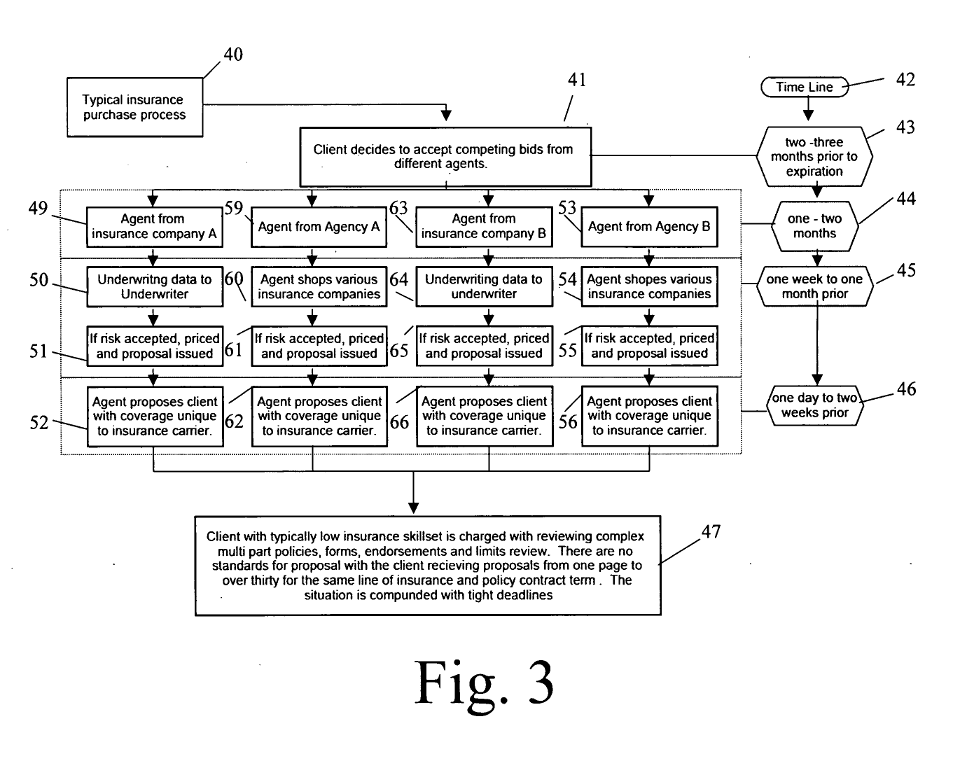

There are two predominant sales channels for the distribution of commercial insurance as shown in FIG. 3 that follow a standard time line 42. The typical insurance purchase process 40 is where a business will engage multiple agents 49, 59, 63, and 53 approximately two to three months prior to expiration of an existing policy 44 to obtain competing bids from different agents 41 and enters into a relationship to receive a proposal with an agent approximately one to two months prior to expiration of an existing insurance contract 44. The other predominant sales channel is though Insurance Companies employing their own sales force to bring their insurance products to market 41.

The agent either has appointments or existing relationships with multiple insurance companies. Approximately one week to one month prior to expiration of an existing insurance policy 45, the agent fills out applications and provides underwriting data to these insurance companies 54 and 64 or an agent shops various insurance companies for rates 60 and 54. The companies then underwrite to decide whether the risk meets their guidelines. If the risk meets their guidelines, a quote is then issued to the agent 51, 61, 65, and 55. Approximately one day to two weeks prior to expiration of an existing insurance policy 46, the agent then presents the proposal(s) to the business 52, 62, 66, and 56.

In this environment, these agents and companies focus on specific sic codes where the insurance need is typically more complex than a standard Business Owners Policy (BOP). The problem that occurs in the typical insurance purchase process 40 is that the business is now is tasked with analyzing a complex insurance proposal, and the expertise required to understand the complex forms or manuscripts is beyond the ability of significant portion of the population 47. In some cases these businesses hire a consultant to review the proposals and complete other related tasks.

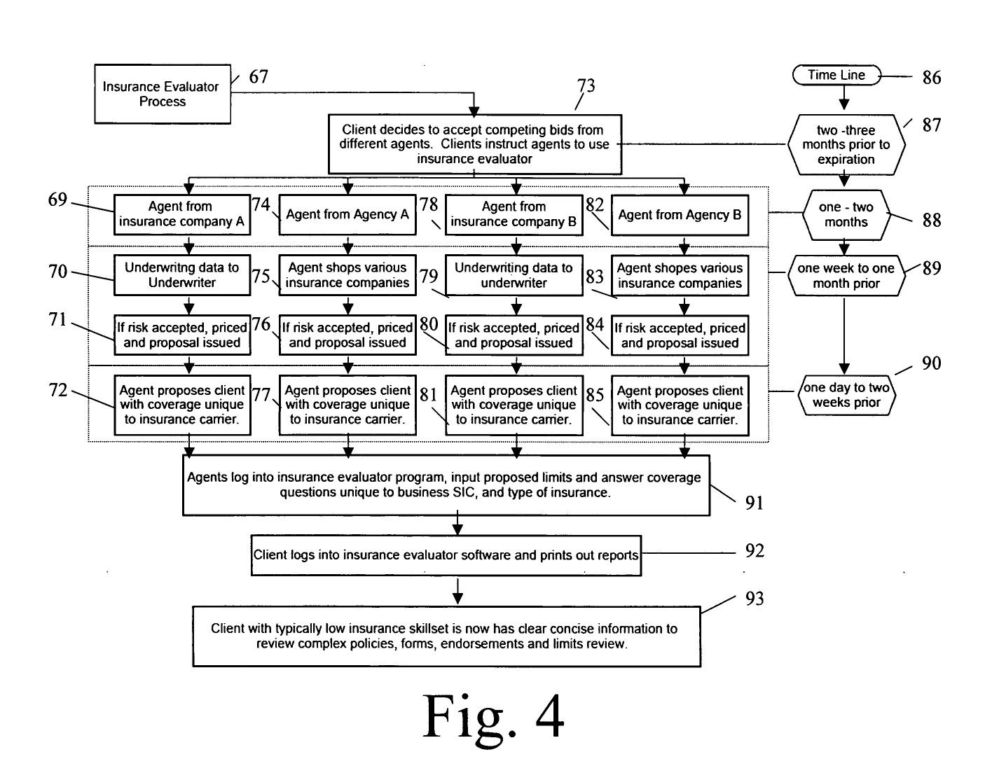

Now referring to FIG. 4, the insurance valuator process 67 differs for the traditional sales process 40 in that when a client decides to accept competing bids from different agents, the client instructs agents to use the insurance valuator system of the present invention 73. The present invention licenses the software to the business.

The insurance valuator process 67 inserts a step in the traditional sales process 40 as illustrated in FIG. 3 where competing insurance agents are responsible for providing limit and coverage information by manual entry into forms residing on our a secure web site 91 of the insurance valuator process 67. The entering of limits may be manual or by electronic means. This is an additional step is not currently utilized in this form.

As an additional embodiment it allows consultants to use the application to assist businesses in evaluating their insurance proposals

The insurance valuator process 67 adds automated management to the sales process, in that it communicates via e-mail, special request such as variable deductibles, deadlines and other pertinent info. The insurance valuator process 67 also notifies the business the insurance company activity in the software via automated communication.

The insurance valuator process 67 compiles the data input from the insurance companies. The insurance valuator process 67 then uses algorithms to create customized reports 92. These reports 92, illustrated in FIGS. 13a-l sort and highlight coverage differences and omissions. In addition the reports 92 give the ramifications of highlighted areas thru both written and multimedia video tracks. Clients with typically low insurance skill sets now have a clear, concise information to review complex policies, forms, endorsements, and limits 93.

In an alternative embodiment, insurance companies can electronically link to the database to eliminate duplicate date entry to obtain even more efficiency.

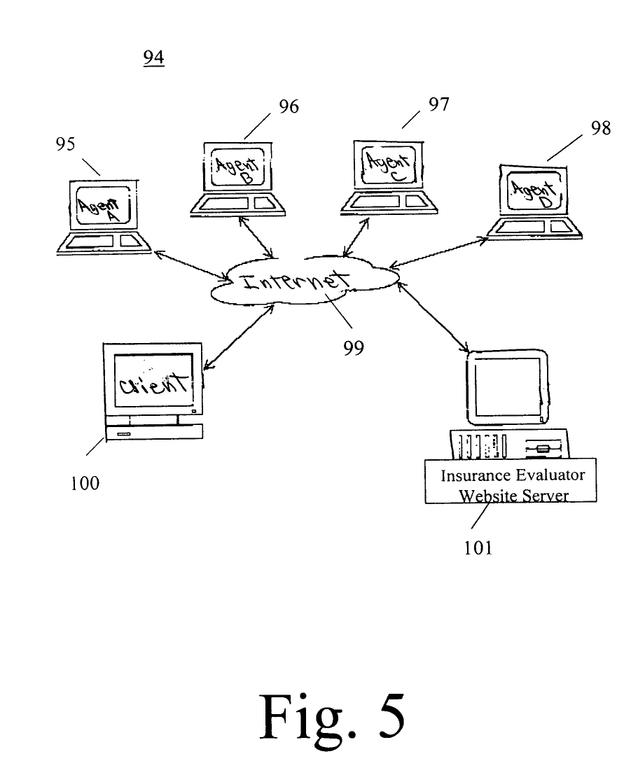

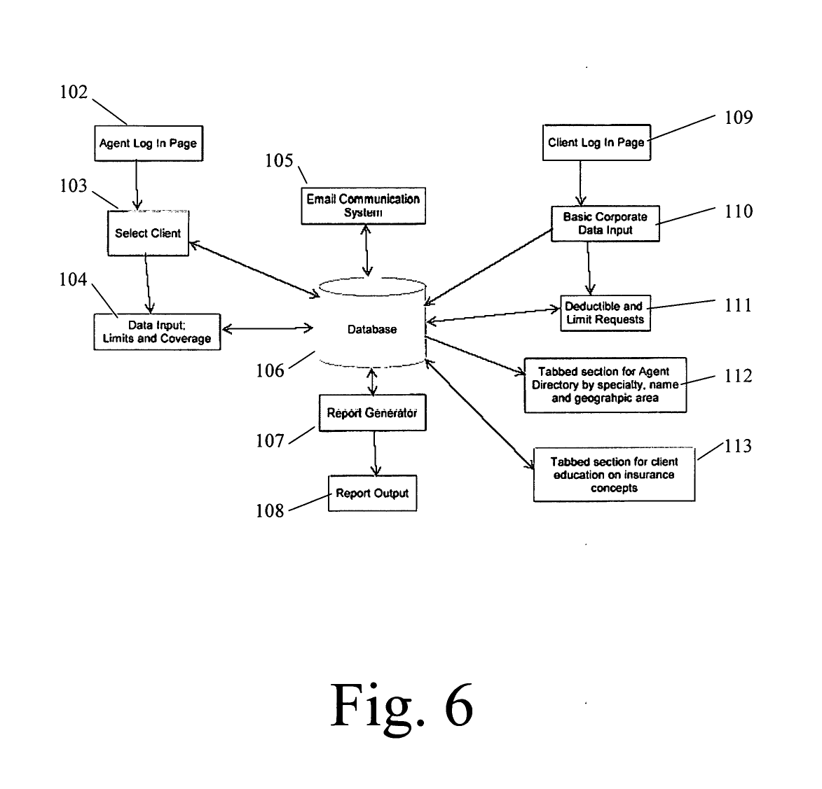

The present invention is embodied and enabled via a website server 101 with a proprietary database that is inserted into the process between the collection of underwriting and the agent review of the proposal with the business owner. The amount of data entry required by the business or client 100 is narrowed to only a few questions since the proposing agents 95, 96, 97, and 98 are responsible for providing their proposal information to the system. FIG. 5 illustrates the physical layout and connectivity of the system 94. A plurality of Agents 95, 96, 97, and 98 may access the insurance valuator website server 101 via the Internet or other multi-user network 99 along with a client 100.

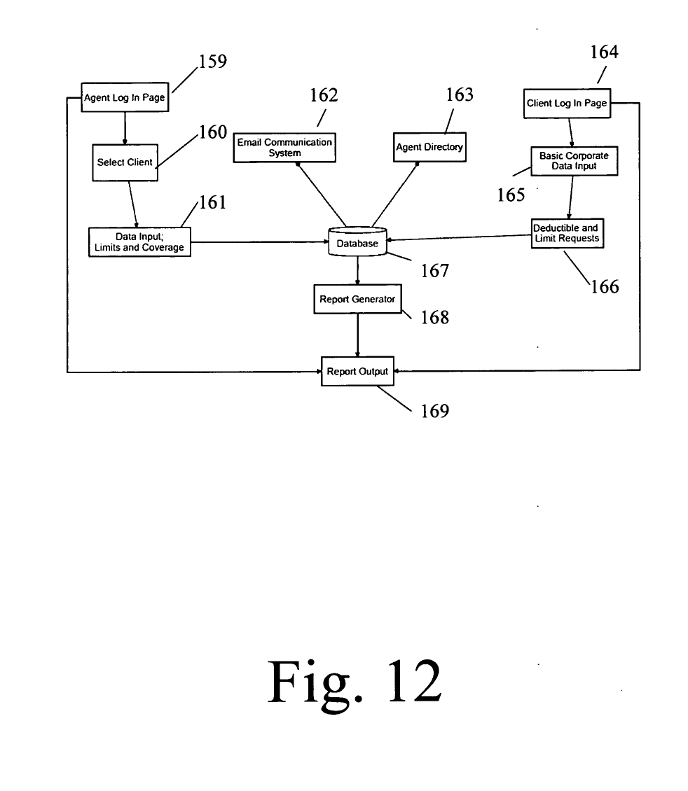

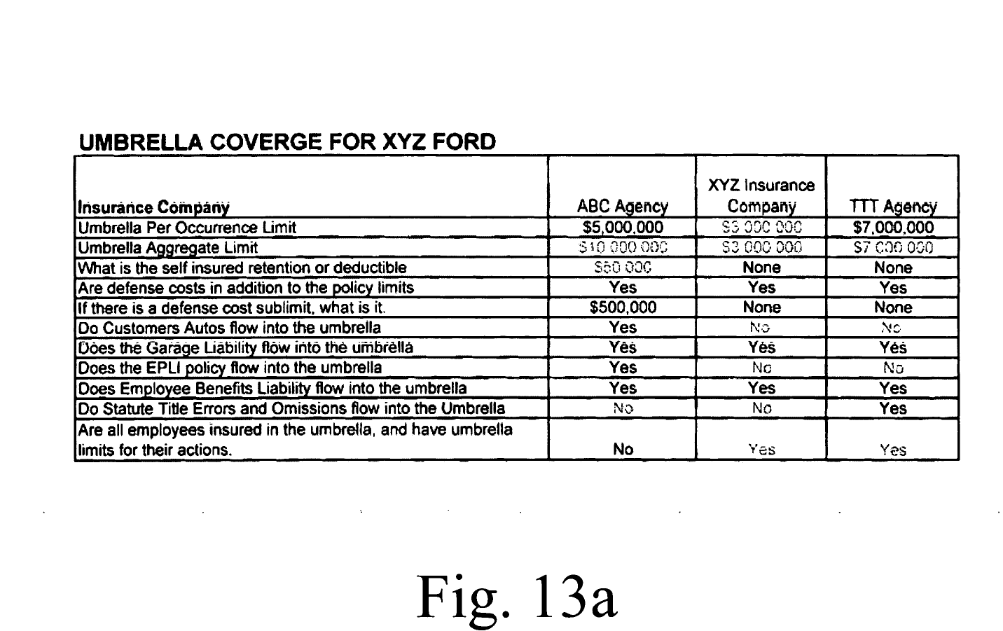

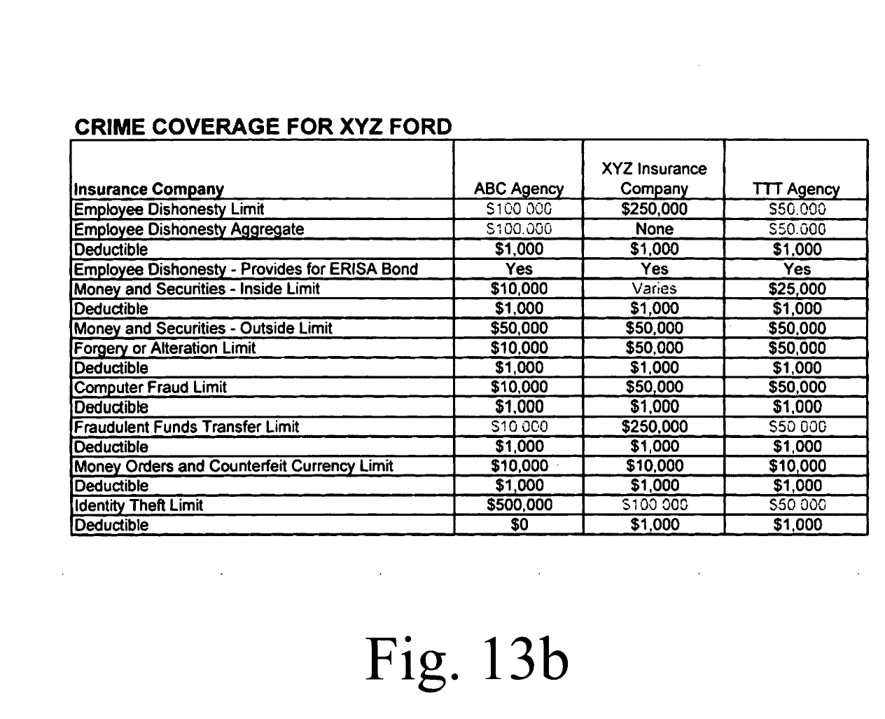

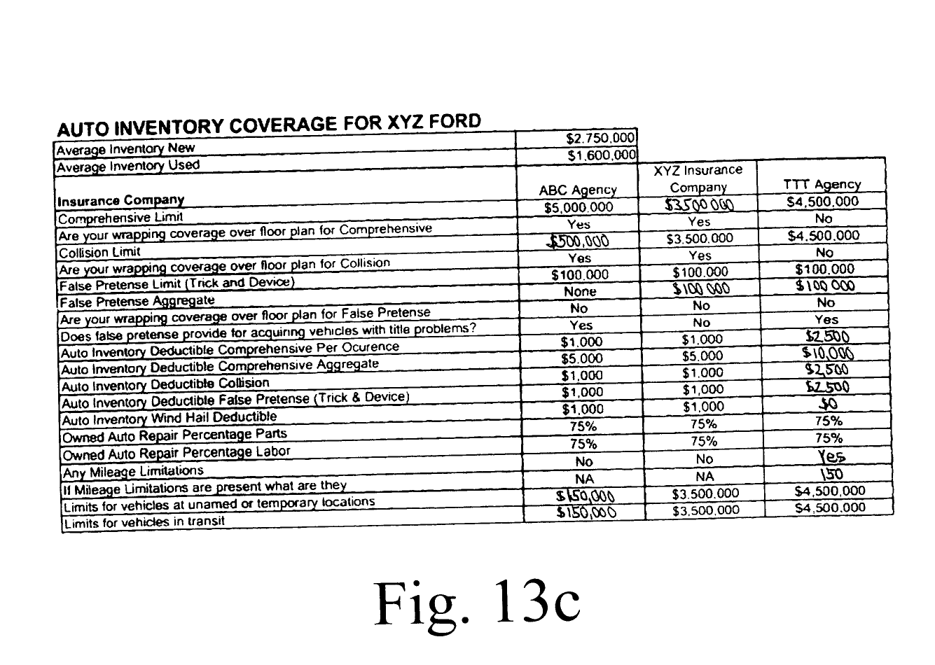

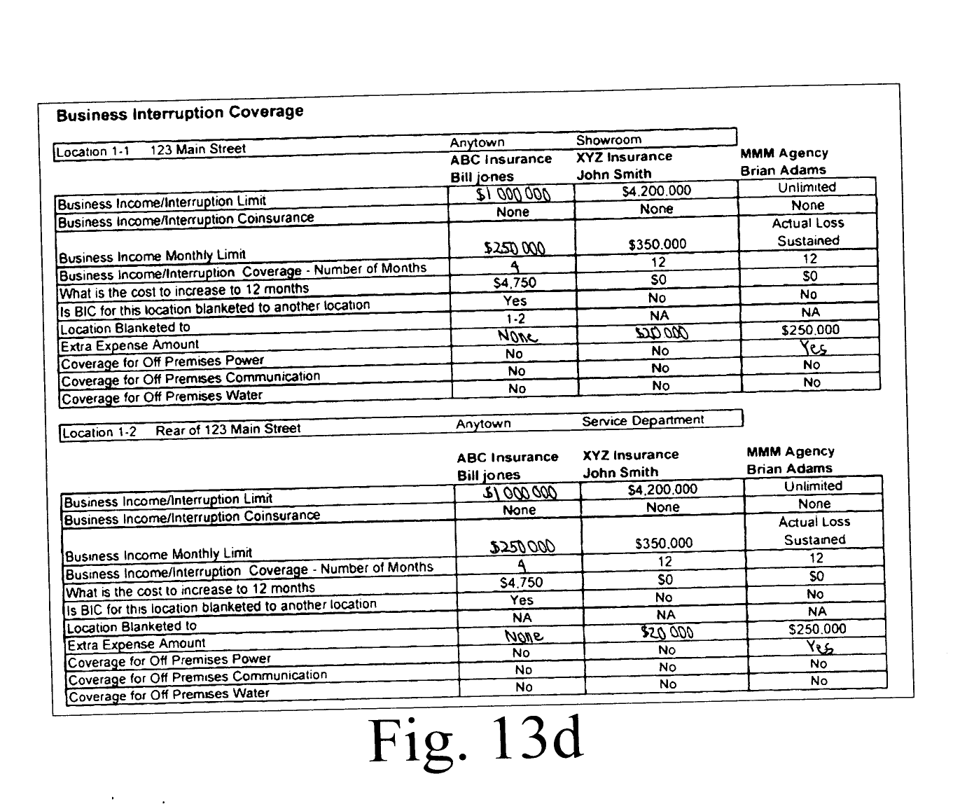

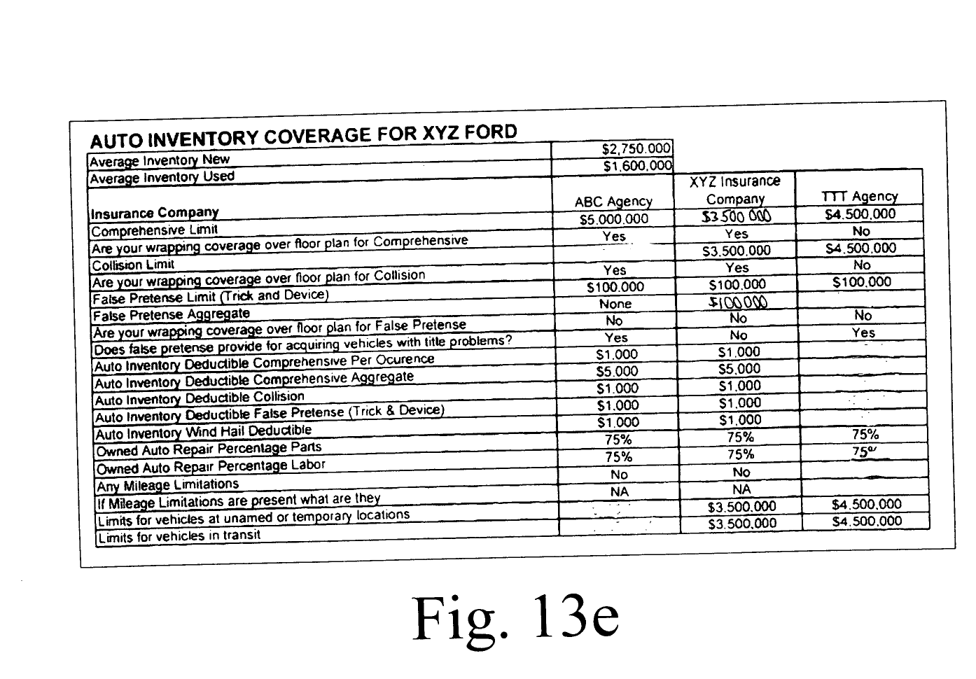

FIG. 12 is a flow chart showing an overview of the system of the present invention. An agent login page 150 allows and agent to select a client 160 and the client's data input 161 from the database 167. Upon the agent's log in and request 159, the database 167 generates as report 168 and then send the report as an output to the agent 169. Upon client log in 164, basic client corporate information is collected 165 with respect to deductible and limit requests 166 which are stored in the database 168. The database also contains an agent directory 163 and an automated communication system 162 to enable communication between agents and clients.

FIG. 6 is a flow chart illustrating the database and functionality of the system of the present invention. An agent first logs into a web page 102 and selects a client 103 from the database 106 for which to enter date input such as limits and coverage terms 104 that are then stored in the database 106. The database then uses an automated communication system 105 to facilitate communication between the agent and the client. The database 106 is further comprised of a report generator 107 that manipulates the data input from the agent 104 to generate reports as output 108 to a client. To access the database 106, a client logs into the server via a web page 109 and inputs basic corporate information 110 for storage on the database 106. This information can include deductible and limit requests 111 and includes a tabbed agent directory that is sorted by agent specialty, name, and geographic area 112. Additionally, a second tabbed section is provided for client education on insurance topics 113 that can be accessed by a client at anytime while logged in the system.

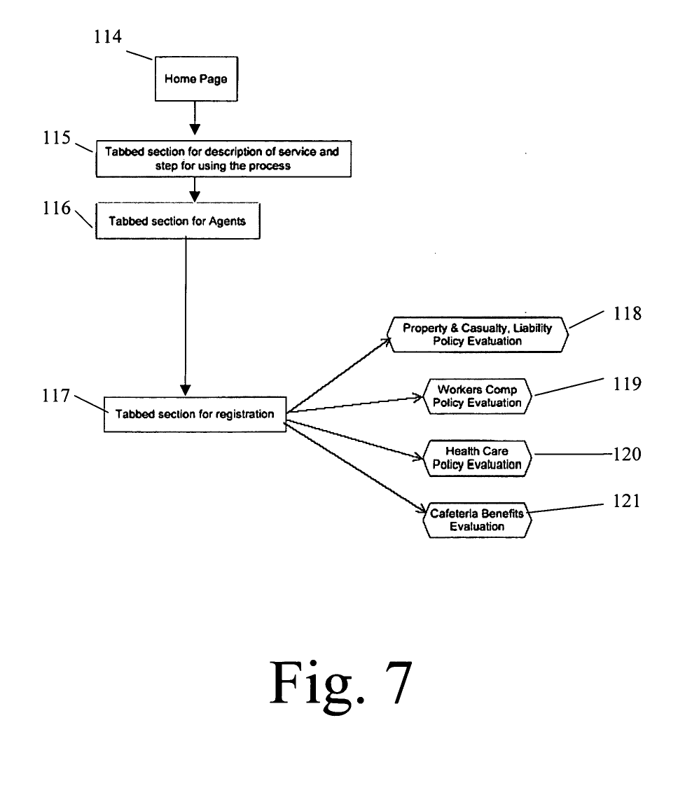

FIG. 7 is a flow chart illustrating the functionality of the tabbed navigation system of the system's home page 114 and web site pages. A tabbed section for description of services and steps for using the process is provided 115 to both clients and agents. A tabbed section for agent information 116 is also provided that enables agents to enter information. A tabbed section for registration 117 includes data entry for property and casualty, liability and policy evaluation 118; worker comp policy evaluation 119; health care policy evaluation 120; and cafeteria benefits evaluation 121.

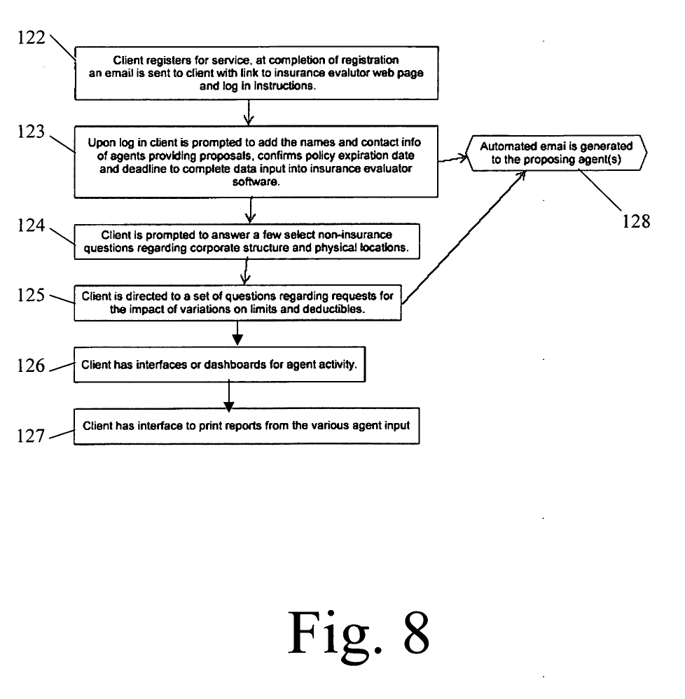

The process steps of a client using the system of the present invention are illustrated in FIG. 8. A client first registered for the service and upon completion of registration an automated communication is sent to the client with a link to the insurance valuator web page and log in instructions 122. Upon log-in a client is prompted to add the names and contact information of agents providing proposals confirms policy expiration date, and deadline to complete date input into the insurance valuator system 123 and an automated communication is generated to the proposing agents 128. Next the client is prompted to answer a few select non-insurance questions regarding corporate structure and physical locations 124. Then the client is directed to a set of questions regarding requests for the impact of variations on limits and deductibles 125 and an automated communication is generated to the proposing agents 128. Finally, the client is provided with interfaces or dashboards 193, 194, and 195 to monitor agent activity 126 and to print reports from the various agent inputs 127.

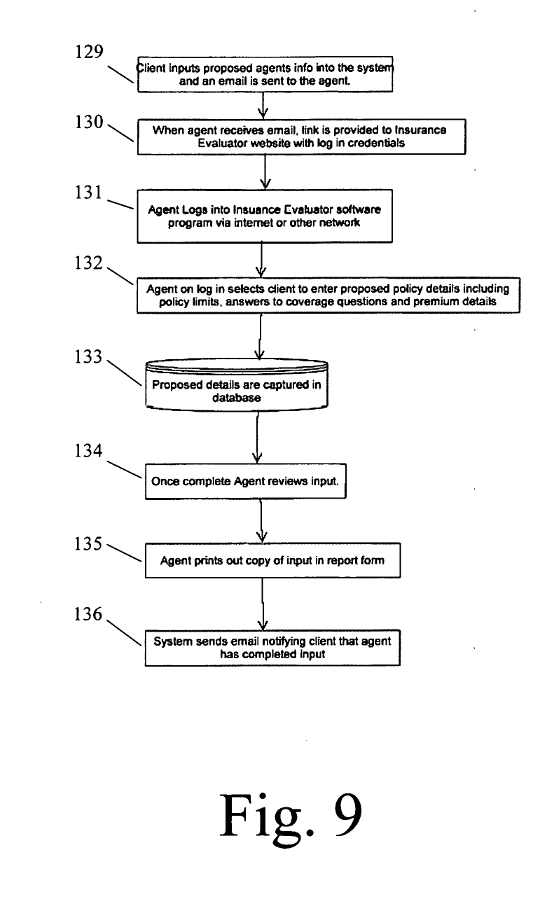

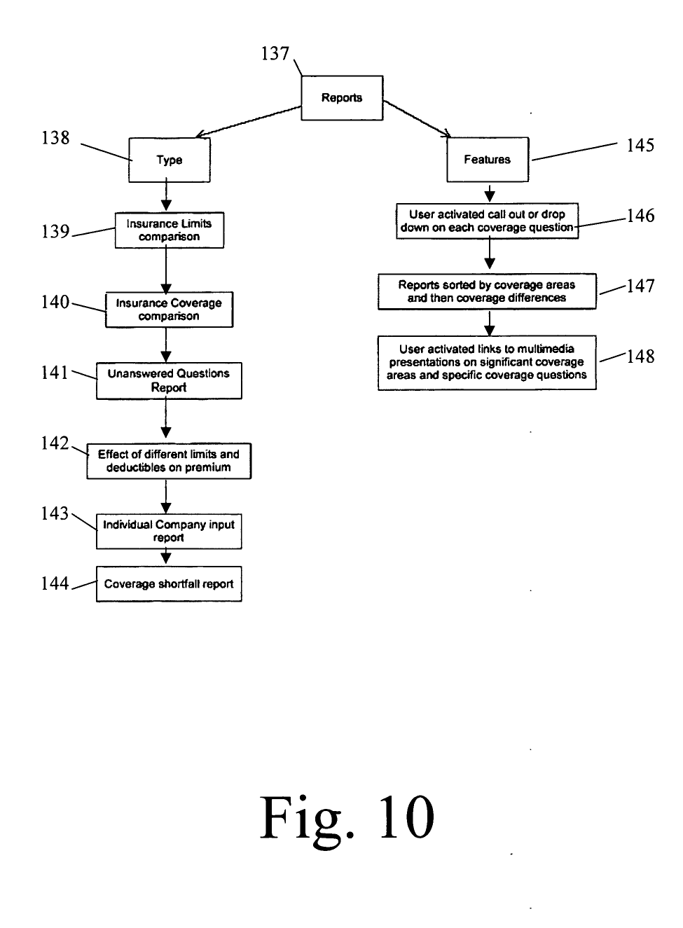

Now referring to FIG. 9, the process steps of an agent using the system of the present invention in response to a client's input are illustrated. First a client inputs proposed agent information into the system and an automated communication is sent to the agents 129. Then, when the agents receive the automated communication, a link is provided to the insurance valuator website with login credentials 130. Next, an agent logs into the insurance valuator via the Internet or multi-user network 131. Upon login, an agent selects the client and enters proposed policy details including policy limits, answers to coverage questions and premium details 132 which are captured in the database 133. Upon completion, the Agent reviews the input 134 and may print out a copy of the input in report form 135 before the system send an automated communication notifying the client that the agent has completed the input 136.

Now referring to FIG. 10 the type 138 and features 145 of reports 137 generated by the present invention are illustrated. The types of reports generated by the system include but are not limited to: insurance limits comparison 139; insurance coverage comparison 140; unanswered questions report 141; effect of different limits and deductibles on premium 142; individual company input reports 143; and coverage shortfall report 144. Each type 138 of report may include the following features: a user activated or call out or drop down on each coverage questions 146; sorting by coverage areas and then coverage differences 147; and user activated links to multimedia presentations on significant coverage areas and specific coverage questions 148.

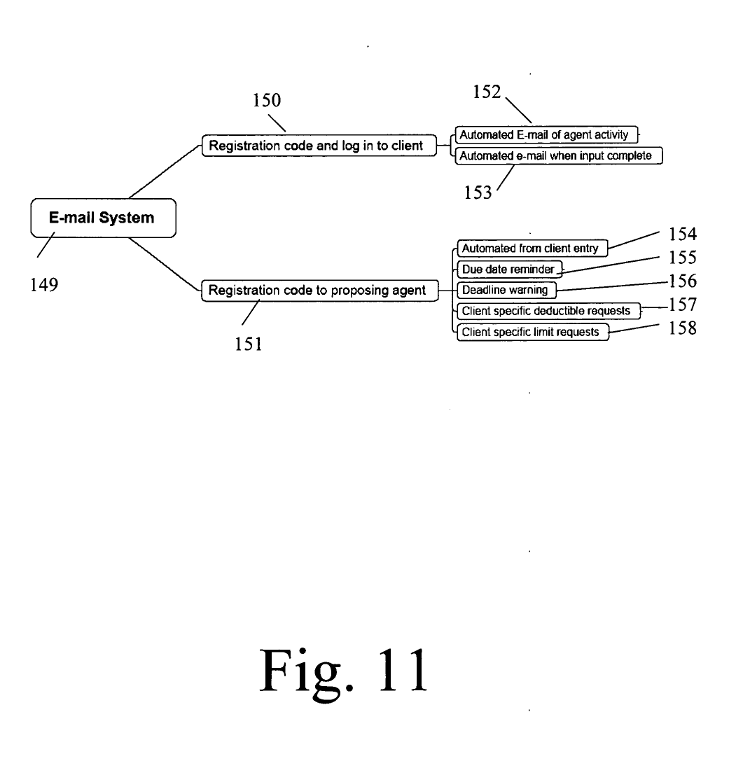

Finally, FIG. 11 is a flow chart illustrating the functionality of the automated communication system component 149 of the present invention. With respect to a client, a registration code is first sent to the client 150 that may be an automated communication of agent activity 152 or an automated communication when input is complete 153. With respect to an agent, a registration code is first sent to the agent 151 that may be: an automated form client entry 154; a due date reminder 155; a deadline warning 156; a client specific deductible requests 157; and client specific limit requests 158.

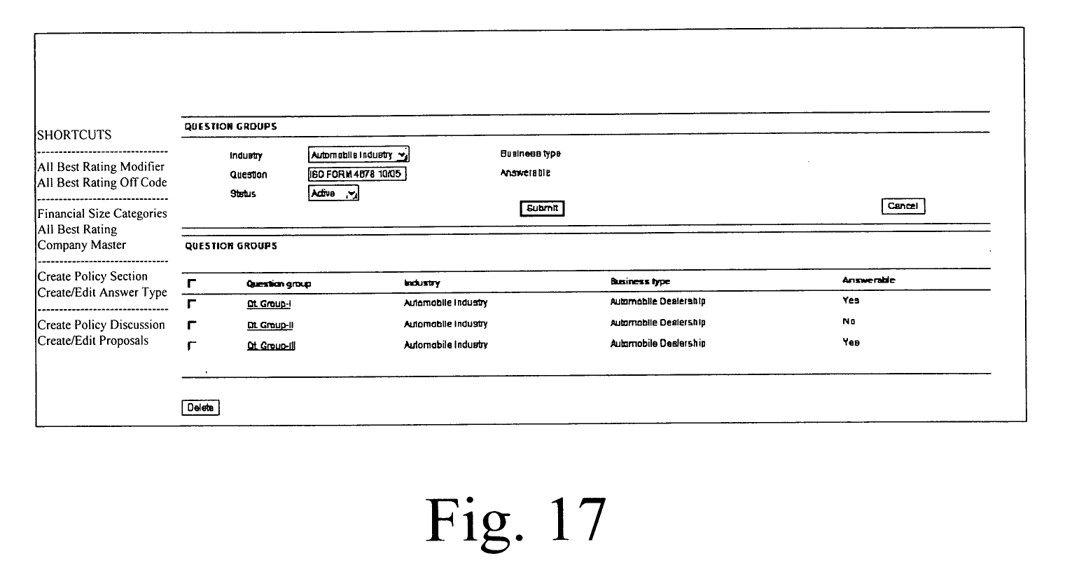

Now referring to FIG. 17, the system of the present invention has a home page for the business to manage the insurance proposal, and a home page 188 for the proposing agents to enter information from their proposals including but not limited to; proposed limits, specific SIC Code related insurance coverage questions, policy enhancements and endorsements, and policy restrictions and endorsements.

The system of the present invention provides for automated communication to the agent and business to manage and ensure timely completion of the proposal by the proposing agents.

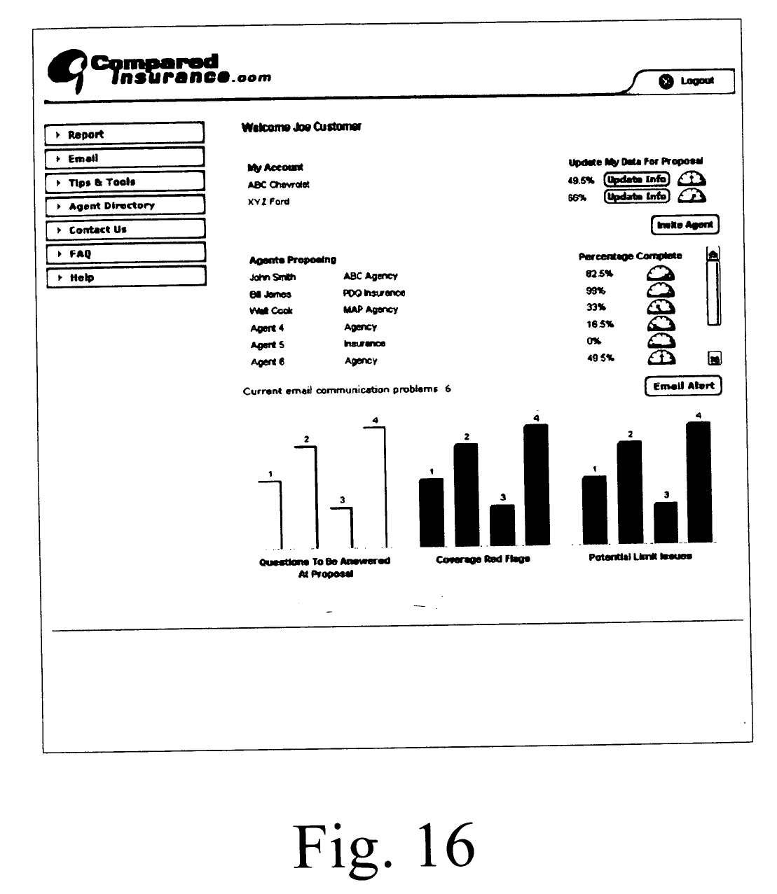

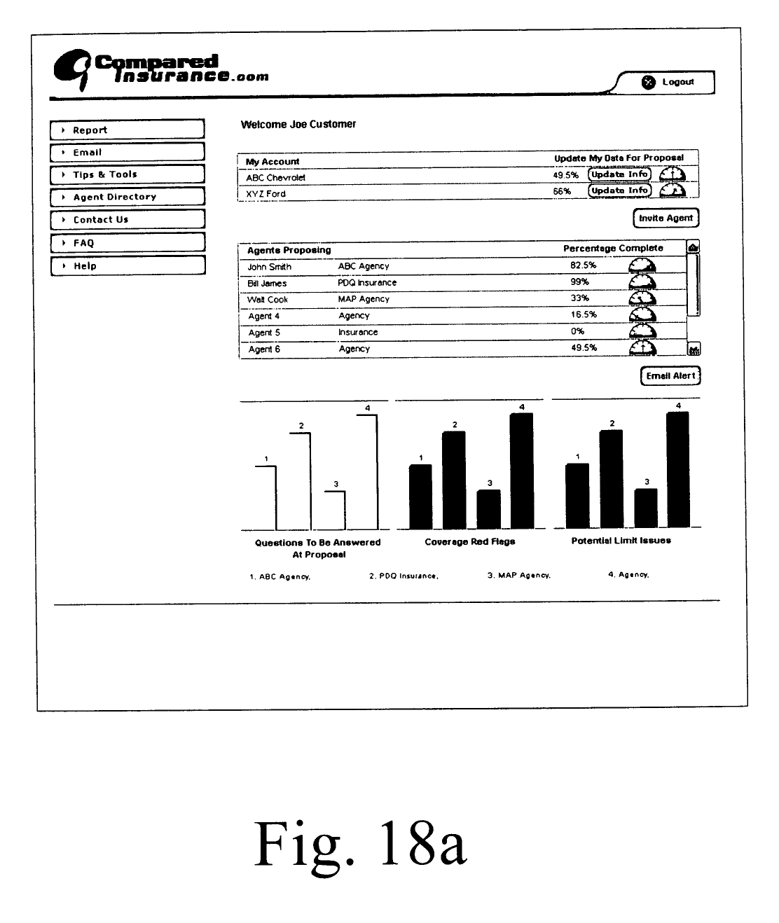

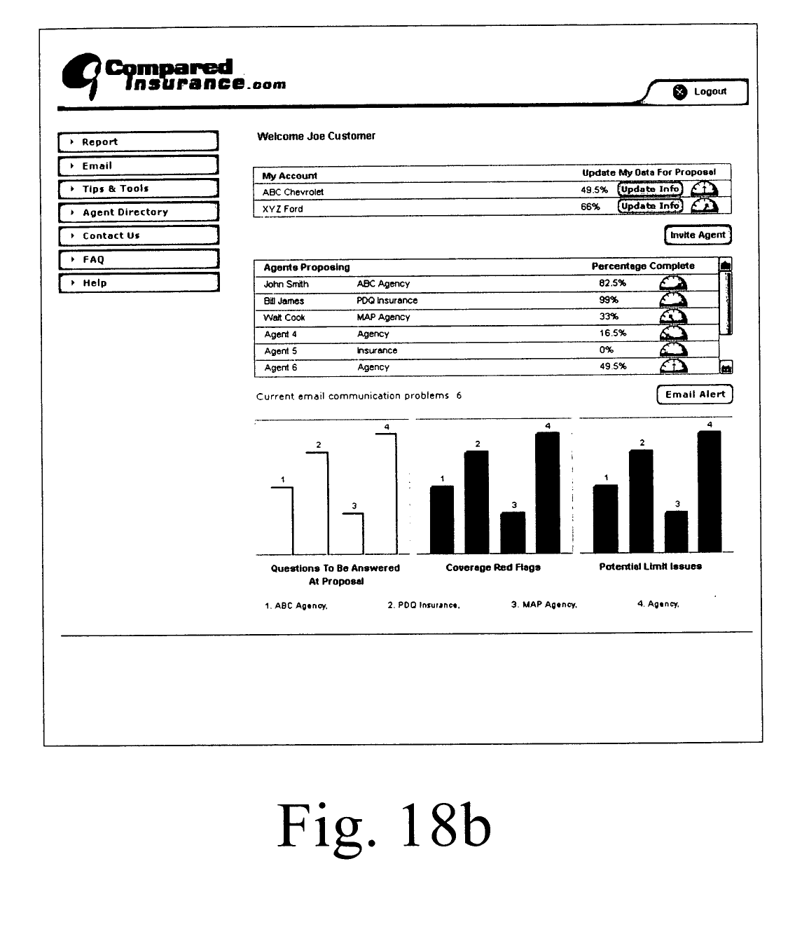

The various components of the Business Home page include dashboards 193, 194, and 195 as illustrated in FIGS. 16 and 18a-18b that show the list of agents proposing the business; the dashboards 193, 194, and 195 show the various details of the business if more than one related corporation is being simultaneously proposed. The status of the process for each agent or company proposing to the business; a section to print out various detail or summary reports from the database; a complete detailed comparison that includes each proposal; a report that compares the limits of insurance being proposed; a report that compares the coverage or contractual language being proposed; a report that highlights and questions not answered by the proposing insurance agents or insurance carriers; a report that shows the effect on premium of different limits and deductibles; and a report that only shows the input of an individual agent or insurance carrier.

The system also includes a section to choose additional deductible or different policy limits if the business wishes to analyze the effects of those variations on the insurance premium; a directory of agents who have agreed to opt in and be listed on our directory; a section that provides forms that the business can use to manage the proposal process; included but not limited to additional detailed coverage questions designed specifically for that business SIC, and detailed interview questions for the proposal and a section for education that includes insurance basics and ways to manage effectively manage the insurance needs, and purchase process.

The various components of the Agent Home page are: a dashboard showing a list and status of all their proposals in progress; a link to each business that they are proposing which when clicked will take them to a page designed to provide navigation for data input of the various coverage parts, such as liability or umbrella coverage as an example. On each business the ability to add coverage from additional insurance companies if there are agents representing more than one insurance carrier. An opt-in button or link if they wish to have their info uploaded to the agent directory. A print function that allows them to print out reports on the information they input into the system.

The automated communication system provides for automated communication, and management of the process. When a business purchases the service, it sends a link and log in codes to the business contact that purchased the system. When a business invites an agent or insurance company to quote, the business inputs the agent's name and automated communication info into fields on the business home page. The input triggers an automated communication to the agent with links back to either a new agent log in or if the agent is registered, his home page. The automated communication also stipulates conditions for the proposal process.

If the business inputs the desire for proposals with multiple limits or deductible choices, an automated communication is sent to the agents notifying them of the request. The automated communication system also is triggered by various input from the agent, an example; when the agent completes input, an automated communication is sent to the business contact notifying him it is complete. The automated communication system also sends reminder notices to agent of the due date to complete the input process. These get more compelling as the due date approaches.

Referring to FIGS. 13a-13l, screen shots of sample reports generated by the present invention are illustrated. Policies can have various coverage terms and limits and each report contains the terms and limits for Umbrella Coverage 170, Crime Coverage 171, Auto Inventory Coverage 172 & 174, Business Interruption Coverage 173, Employee Benefits Coverage 175, Employment Practices Liability Coverage 176, Errors and Omission Coverage 177, Garage Liability 179, Pollution Coverage 180, Contents Limits Coverage, and specific questions with respect to Liability Coverage 178.

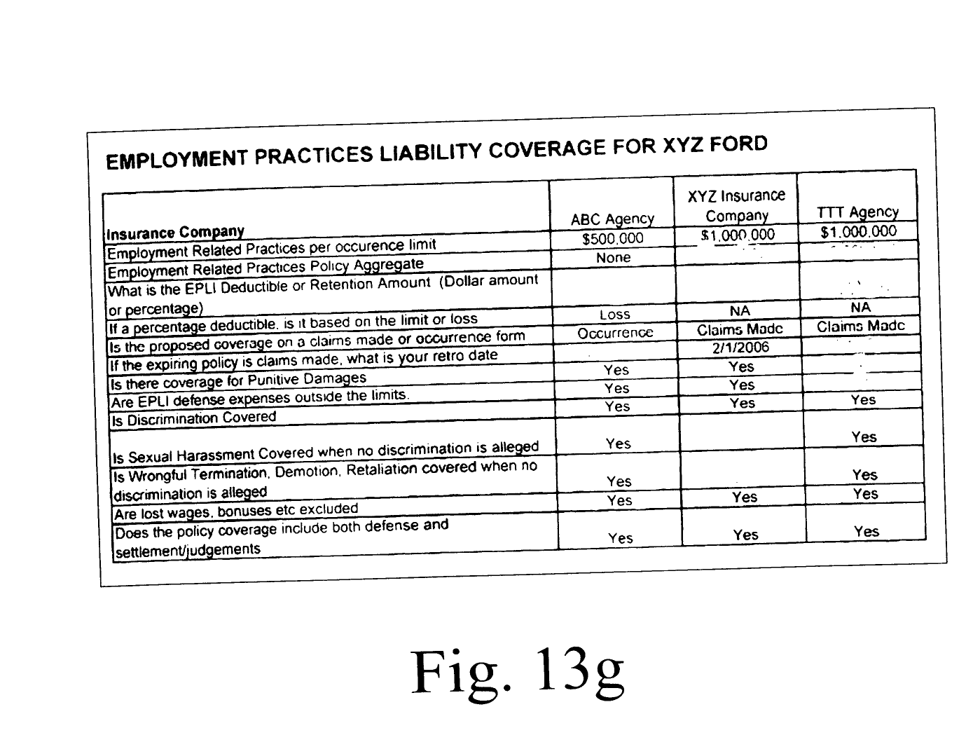

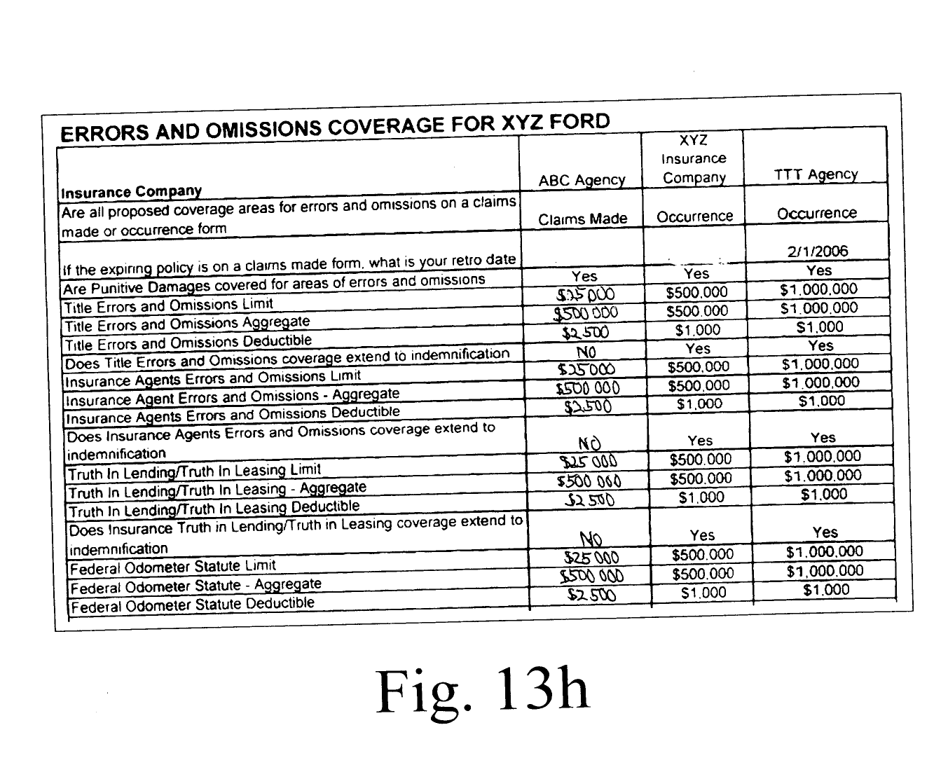

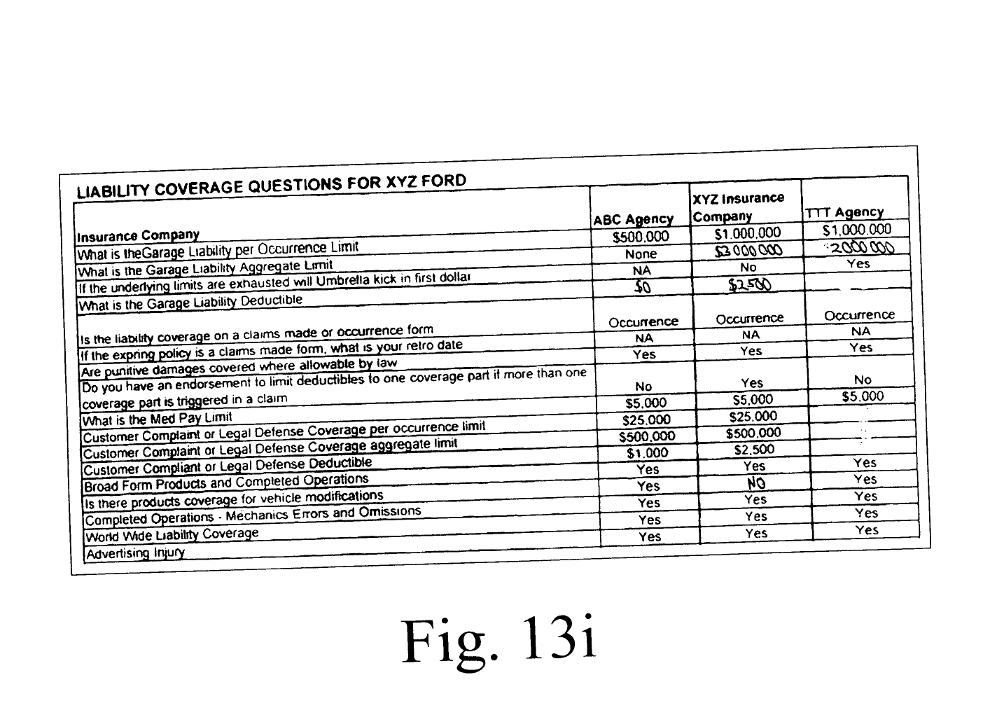

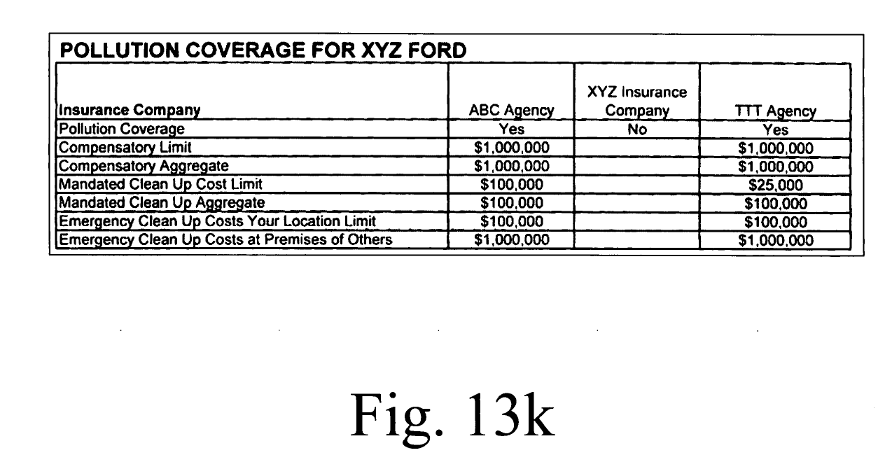

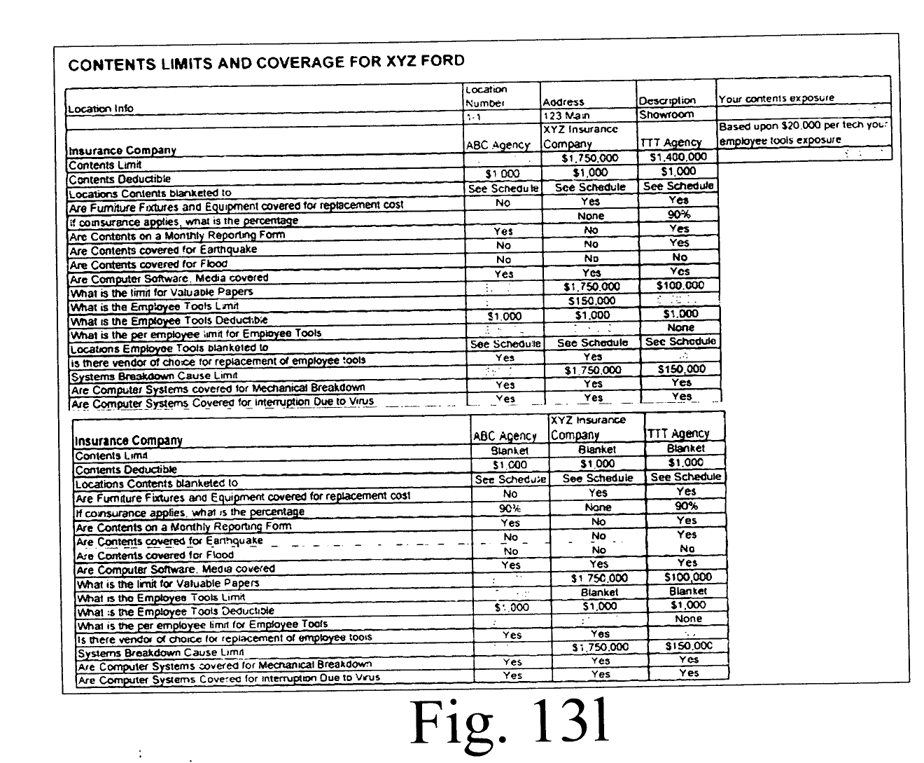

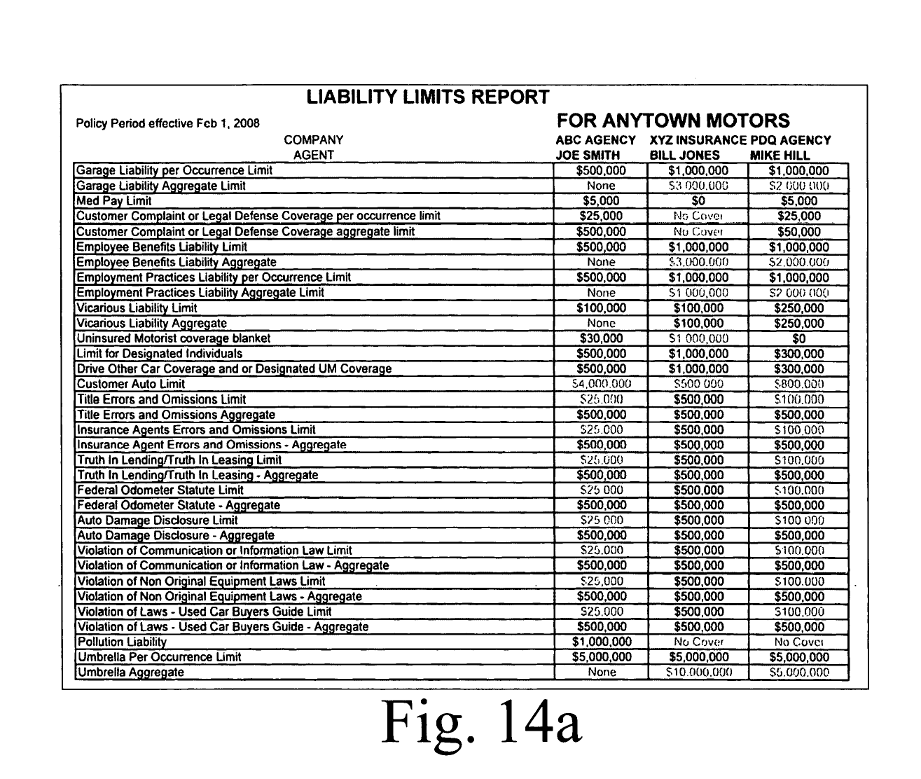

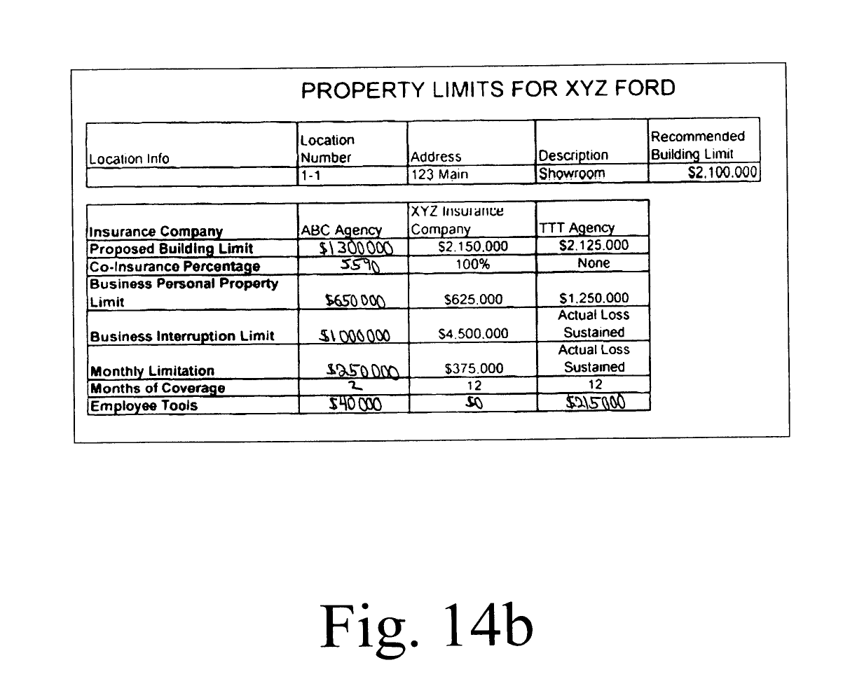

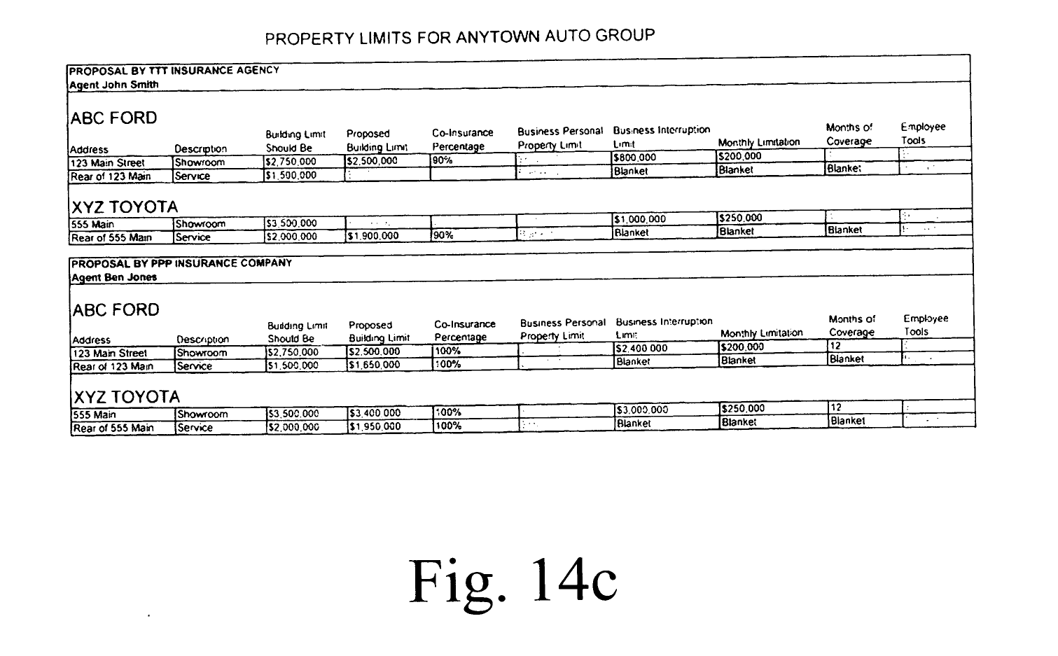

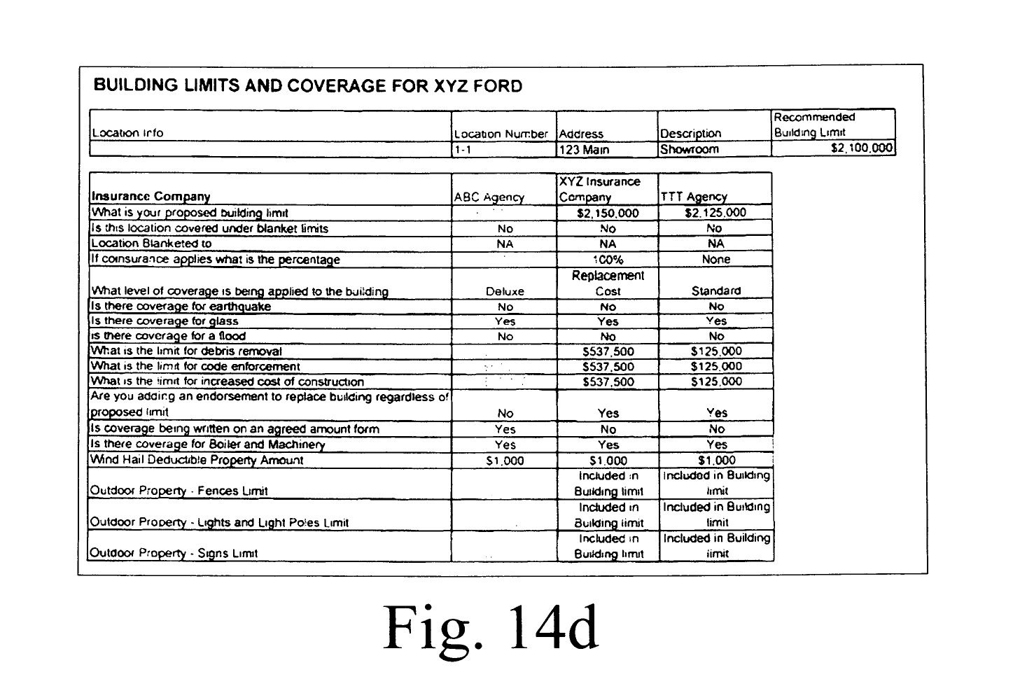

Now referring to FIGS. 14a-14d, screen shots of sample reports of liability limits generated by the present invention are illustrated such as those for Liability Limits 182, Property Limits 183 & 184, Building Limits and Coverage 185, Alternative Deductibles 186, and Deductible Differences 187.

### Alternative Embodiment

In an alternative embodiment, instead of the client printing their own reports, as illustrated in FIGS. 4 and 8, consultants may be involved in the process and become members of the system, use the system, or be hired by clients to use the system and evaluate the reports generated by the system as if they were the client. In such an embodiment, the introduction or use of a consultant results in an alternative embodiment of the preferred embodiment of the present invention that essentially adds a step to the process of the preferred embodiment of the present invention where the consultant presents their findings to the client rather than the client printing their own reports and interpreting the information on their own without outside or additional assistance.

Thus, it is appreciated that the optimum dimensional relationships for the parts of the present invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for analyzing complex insurance policy proposals, comprising the steps of:
engagement by a business with one or more agents prior to expiration of an existing policy;
obtaining competing bids from one or more agents;
entry into a relationship with one or more agents prior to expiration of an existing insurance contract to accept a proposal for their insurance needs;
appointments by one or more agents with one or more insurance companies;
filling out applications and providing underwriting data to said insurance companies by said agents
determination by insurance companies as to whether to underwrite based on whether the risk meets their guidelines;
if the risk meets their guidelines, providing a quote to said agent;
presenting the proposals to the business prior to expiration of an existing insurance policy by the broker or agent;

2. The method for analyzing complex insurance policy proposals of claim 1, wherein
agents and businesses focus on specific sic codes;
the business is tasked with analyzing a complex insurance proposals, and the expertise required to understand the complex forms or manuscripts as well as the differences between them and
the business hires a consultant to prepare bid specifications, create requests for proposals, and review the proposals received.

3. The method for analyzing complex insurance policy proposals of claim 1, wherein
a business decides to accept competing bids from a plurality of agents; and
the business instructs agents to use an insurance valuator system

4. The method for analyzing complex insurance policy proposals of claim 3, wherein
competing agents are responsible for providing limit, deductible and coverage information by either manual entry into forms residing a secure web site of the insurance valuator system or through electronic means; and
the consultants review the reports from the insurance valuator system and present the findings and recommendations to the business.

5. The method for analyzing complex insurance policy proposals of claim 3, wherein the insurance valuator:
adds automated management to the sales process;
communicates via e-mail, special requests such as variable deductibles, deadlines and other pertinent information;
notifies the business of broker, agent, and insurance company activity in the system via automated communication;
compiles the data input from the agents and insurance companies; and
uses algorithms to create customized reports.

6. The method for analyzing complex insurance policy proposals of claim 5, wherein the reports
sort and highlight coverage differences and omissions; and
provides the ramifications of highlighted areas through either written and or multimedia presentation;

7. The method for analyzing complex insurance policy proposals of claim 1, further comprising the steps of
inserting a step in the traditional sales process where competing agents are responsible for providing limit and coverage information by manual entry into forms residing on our secure web site, or by electronic transmission to our database;
licensing the system and method to a business;
providing manual entry or entry via an electronic interface;
adding automated management to the sales process, in that it communicates via e-mail, special request such as variable deductibles, deadlines and other pertinent information;
notifying the business of the insurance company activity in the software via automated communication;
compiling the data input from the insurance companies;
creating customized reports from proprietary algorithms;
sorting and highlight coverage differences and omissions; and
providing ramifications of highlighted coverage differences and omissions by both written and multimedia tracks.

8. The method for analyzing complex insurance policy proposals of claim 1, wherein
the business gives underwriter data to several agents of direct writers and independent agents;
a plurality of direct writers then gives the data to the direct writer's underwriters and a plurality of unique proposals are then issued with insurance company specific endorsements and coverage forms;
a plurality of agents are provided underwriting data by a business and said agents then each individually generate a unique proposal with insurance company specific endorsements and coverage forms;
a business can then choose to schedule a review of each proposal with each competing agent and writer to review each proposal; and
the business is then responsible for reviewing each proposal to make a decision.

9. The method for analyzing complex insurance policy proposals of claim 2, wherein
the consultants are hired by the businesses;
the consultants collect underwriting data;
the consultants create a Request for Proposal;
the consultants pass on the underwriting data and policy requirements to insurance companies or agents;
insurance agents and or insurance company representatives input their proposed coverage and limits into the insurance valuator system;
the consultants receive proposals from the insurance companies or agents;
the consultants access and analyze reports from the insurance valuator system;
said consultants evaluate reports as if they were the client;
said consultants presents their findings to the business; and
said consultants interpret the information without outside or additional assistance.

10. A system for analyzing complex insurance policy proposals comprising:
a website server;
a database providing means for the collection of underwriting and agent review of proposals with a business;
said database also providing an insurance valuator website server;
a multi-user network providing a plurality of agents insurance companies, and businesses access to said web server and database;
means for enabling to enter their proposal information into the database by an agent, business or third party; and
means for a business to provide underwriting data to those wanting to provide quotes.

11. The system for analyzing complex insurance policy proposals of claim 10 wherein
the insurance agent logs on to the system and completes forms regarding limits and coverages;
an automated communication is generated and sent to the business when the agent logs in and when the forms are complete;
when proposal information is uploaded, custom reports are generated that can be viewed by the business such as summary reports, detail reports, red flag identification, or difference reports;
a business can sign on to the system at any time to retrieve reports;
reports are provided that compare the competing proposals giving detailed comparative information on each proposal where all areas of difference or omission are highlighted;
when an agent gives their proposal, businesses can have an agent sign to confirm coverages;
business owners schedule a review of the proposals with the competing agents; and
if coverage is selected, business owners can print out winning agents input for signature verification.

12. The system for analyzing complex insurance policy proposals of claim 10 wherein the database further comprises an agent directory and an automated communication system to enable communication between agents and clients.

13. The system for analyzing complex insurance policy proposals of claim 10 wherein an agent login page provides means for an agent to select a client and the client's data input from the database and generate a report and then send the report as an output to the agent.

14. The system for analyzing complex insurance policy proposals of claim 10 wherein basic client corporate information is collected including deductible and limit requests which are stored in the database.

15. The system for analyzing complex insurance policy proposals of claim 10 wherein
an agent first logs into a web page and selects a client from the database for which to enter date input such as limits and coverage terms that are then stored in the database;
the database then uses an automated communication system to facilitate communication between the agent and the client; and
the database is further comprised of a report generator that manipulates the data input from the agent to generate reports as output to a client.

16. The system for analyzing complex insurance policy proposals of claim 10 wherein
a client logs into the server via a web page and inputs basic corporate information for storage on the database;
said information includes deductible and limit requests;
said database includes a tabbed agent directory that is sorted by agent specialty, name, and geographic area; the ability to request a proposal from an agent listed in the directory; and
said database includes client education on insurance topics that can be accessed by a client at anytime while logged in the system.

17. The system for analyzing complex insurance policy proposals of claim 10 further comprising
a navigation system providing means for a description of services and steps for using the process to both clients and agents;
a navigation system for agent information providing means for agents to enter information; and
a navigation system for registration providing means for data entry for the various business insurance categories.

18. The system for analyzing complex insurance policy proposals of claim 10 further comprising
upon completion of registration by a business, an automated communication is sent to the business with a link to the insurance valuator web page and log in instructions;
upon log-in, a business is prompted to add the names and contact information of agents being requested to provide proposals, confirm policy expiration date, and the deadline to complete date input into the insurance valuator system, and an automated communication is generated to the proposing agents or insurance companies;
the business owner can request a proposal from agents listed in the directory,
the business answers non-insurance questions regarding corporate structure and physical locations;
the business is directed to a set of questions regarding requests for the impact of variations on limits and deductibles and an automated communication is generated to the proposing agents and insurance companies; and
the business is provided with interfaces or dashboards to monitor agent activity and to output reports from the various agent inputs.

19. The system for analyzing complex insurance policy proposals of claim 10 further comprising the steps of:
a business inputting proposed agent information into the system and an automated communication is sent to the agents;
when the agents and insurance companies receive the automated communication, a link is provided to the insurance valuator website with log-in credentials;
an agent and insurance companies logs into the insurance valuator via the Internet or multi-user network;
upon log-in, a agents and insurance companies selects the business and enters proposed policy details including policy limits, answers to coverage questions and premium details which are captured in the database; and
upon completion, the agents and insurance companies reviews the input and may print out a copy of the input in report form before the system sends an automated communication notifying the client that the agent has completed the input.

20. The system for analyzing complex insurance policy proposals of claim 11 wherein
the types of reports generated by the system include but are not limited to: insurance limits comparison; insurance coverage comparison; unanswered questions report; effect of different limits and deductions on premiums; individual company input reports; and coverage shortfall report; and
each type of report may include a user activated or call out or drop down on each coverage questions; sorting by coverage areas and then coverage differences; and user activated links to multimedia presentations on significant coverage areas and specific coverage questions.

21. The system for analyzing complex insurance policy proposals of claim 12 wherein
the automated communication system, with respect to a business, first sends a registration code to the business that may be an automated communication of agent activity or an automated communication when input is complete; and
the automated communication system, with respect to an agent, first sends a registration code to the agent that may be: an automated form client entry; a due date reminder; a deadline warning; a client specific deductible requests; and client specific limit requests.

22. The system for analyzing complex insurance policy proposals of claim 19 wherein
the consultants collect underwriting data;
the consultants create a Request for Proposal;
the consultants pass on the underwriting data and policy requirements to insurance companies or agents;
agents input their proposed coverage and limits into the insurance valuator system;
the consultants receive proposals from the insurance companies or agents;
the consultants access and analyze reports from the insurance valuator system;
consultants are hired by the business;
said consultants evaluate reports as if they were the client;
said consultants presents their findings to the business; and
said consultants interpret the information without outside or additional assistance.

23. The system for analyzing complex insurance policy proposals of claim 19 wherein
the business may input or have inputted, their current policy so that it can be compared against a red flag and rules stored on the database; and
said database generating resulting reports that allow businesses to understand their current coverage and its weaknesses and strengths in comparison to established rules, other policies, or red flagged issues.

24. The system for analyzing complex insurance policy proposals of claim 19 further comprising:
a valuator system that creates a report that lists all of the major terms of the policy as inputted, which is then signed by the agent, providing the business a more thorough outline and means for understanding of the policy that was purchased; and
providing means for the business to compare what was purchased to the policy when it is finally received.
